(19) United States
(12) Patent Application Publication
(10) Pub. No.: US 2023/0312029 A1
(43) Pub. Date: Oct. 5, 2023

(54) APPARATUS AND METHOD FOR SHIFTING TRAILERS

(71) Applicant: ELECTRANS TECHNOLOGIES LTD., Oakville (CA)

(72) Inventors: Brian Layfield, Oakville (CA); Brian FAN, Oakville (CA); Anthony IGHOMUAYE, Oakville (CA)

(21) Appl. No.: 18/044,554

(22) PCT Filed: Sep. 9, 2021
(86) PCT No.: PCT/CA2021/051245

§ 371 Date: Mar. 8, 2023

Related U.S. Application Data
(60) Provisional application No. 63/075,863, filed on Sep. 9, 2020.

(51) Int. Cl. B62D 53/00; B60L 50/60; B62D 59/04; B62D 13/00; B62D 11/00; B62D 11/04; B60L 15/20

(52) U.S. Cl. CPC B62D 53/005; B60L 50/60; B62D 59/04; B62D 13/00; B62D 11/003; B62D 11/04; B60L 15/20; B60L 2200/28; B60L 2260/20; B62D 53/0864

(57) ABSTRACT

The disclosure is directed at an apparatus and method for shifting or moving trailers. In one aspect, the apparatus is a converter dolly with at least one set of powered wheels, which can be equipped with a remote control steering device. In another aspect, the apparatus is a remotely controlled terminal tractor configured to be coupled to a trailer. In some aspects, the remote control of the apparatus is directed by an autonomous algorithm resident remotely or on the apparatus itself. In another aspect, a frame of an apparatus for towing a trailer includes an articulated frame with a first frame counterpart pivotably connected to a second frame counterpart.

### FIELD

This disclosure relates generally to the road transportation industry. More specifically, the disclosure is directed at a method and apparatus for shifting trailers within a drop yard or other location by remote control.

### BACKGROUND

Transportation of goods across road networks is typically accomplished by way of a transport truck to which a transport trailer is attached. The truck provides the engine and the trailer provides the cargo space to transport goods. A recent trend in the transportation of goods by road is the expansion of the size of transport trucks. This expansion is accomplished by both larger trucks and larger trailers. Fewer trips with larger loads can be more efficient in certain circumstances. One way to achieve larger loads is to add a pup trailer, also called a second trailer, behind the main trailer (also called a first trailer). A transport trailer with the pup trailer may be called a transport trailer train.

The typical equipment used to attach a pup trailer to a transport trailer is called a converter dolly. Current convertor dollies are passive and limited in their use and application. They provide a set of wheels to support the front end of the pup (secondary) trailer and a connector assembly for connecting to the rear end of the main (primary) trailer.

### SUMMARY

The present disclosure describes a converter dolly apparatus with an electrical kinetic energy recovery device for capturing braking energy. A number of applications are described, including regenerative braking and active electrical motor control of the dolly wheels for improving the fuel economy of transport trucks. Further, the present disclosure describes an apparatus for towing trailers, said apparatus including an articulated frame.

In an aspect, there is provided an apparatus for releasably coupling a second trailer to a first trailer that is releasably coupled to a towing vehicle in a tractor-trailer vehicle configuration, the apparatus comprising: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; an energy storing device for storing energy; at least one motor operably coupled to: (i) at least one wheel of the front pair of wheels and the rear pair of wheels for applying rotational force to the at least one wheel, and (ii) the energy storing device for receiving energy, such that the motor is operable in a drive mode for applying a motive rotational force to the at least one wheel; and a controller for selectively activating the drive mode of the motor; a steering device communicatively coupled to the controller for steering the apparatus, the apparatus being operable by the steering device to shunt the second trailer around a staging area when the second trailer is disconnected from the towing vehicle, wherein the at least one wheel, the motor, and the energy-storing device are co-operatively configured such that while the first trailer is released from the releasable coupling to the apparatus and the releasable coupling of the second trailer to the apparatus is effected, and while the energy is stored on the energy storing device, the motor is operable in the drive mode such that the second trailer translates with the apparatus; and the apparatus is steerable by effecting pivoting of one of the first frame counterpart and the second frame counterpart pivots relative to the other of the first frame counterpart and the second frame counterpart.

In another aspect, there is provided a terminal tractor apparatus for towing trailers, the apparatus comprising: a first frame counterpart and a second frame counterpart that are pivotably connected to define a frame; a trailer connector assembly disposed on the second frame counterpart for releasably coupling the apparatus to a trailer such that the trailer translates with the apparatus; a front pair of wheels rotatably coupled to the first frame counterpart; a rear pair of wheels rotatably coupled to the second frame counterpart; an energy storing device for storing energy; at least one motor operably coupled to at least one wheel of the front pair of wheels and the rear pair of wheels for applying rotational force to the at least one wheel and to the energy storing device for receiving energy, such that the motor is operable in a drive mode for applying a motive rotational force to the at least one wheel; and a controller for selectively activating the drive mode of the motor; a steering device communicatively coupled to the controller for steering the apparatus, the apparatus being operable by the steering device to shunt the trailer around a staging area while the trailer is releasably coupled to the apparatus; wherein the at least one wheel, the motor, and the energy-storing device are co-operatively configured such that while the trailer is releasably coupled to the apparatus, and while the energy is stored on the energy storing device, the motor is operable in the drive mode such that the trailer translates with the apparatus; and the apparatus is steerable by effecting pivoting of one of the first frame counterpart and the second frame counterpart pivots relative to the other of the first frame counterpart and the second frame counterpart.

In another aspect, there is provided a terminal tractor apparatus for towing trailers, comprising: a first frame counterpart and a second frame counterpart that are pivotably connected to define a frame; a trailer connector assembly disposed on the second frame counterpart for releasably coupling the apparatus to a trailer such that the trailer translates with the apparatus; a front pair of wheels rotatably coupled to the first frame counterpart; a rear pair of wheels rotatably coupled to the second frame counterpart; an energy storing device for storing energy; at least one motor operably coupled to at least one wheel of the front pair of wheels and the rear pair of wheels for applying rotational force to the at least one wheel and to the energy storing device for receiving energy, such that the motor is operable in a drive mode for applying a motive rotational force to the at least one wheel; and an actuator that is disposed in operable communication with the first frame counterpart and the second frame counterpart, and is co-operatively configured with the first frame counterpart and the second frame counterpart such that the actuator is activatable to effect pivoting of one of the first frame counterpart and the second frame counterpart relative to the other of the first frame counterpart and the second frame counterpart; a controller for: selectively activating the drive mode of the motor; and selectively activate the actuator; a steering device communicatively coupled to the controller for steering the apparatus, the apparatus being operable by the steering device to shunt the trailer around a staging area while the trailer is releasably coupled to the apparatus; wherein the at least one wheel, the motor, and the energy-storing device are co-operatively configured such that while the trailer is releasably coupled to the apparatus, and while the energy is stored on the energy storing device, the motor is operable in the drive mode such that the trailer translates with the apparatus; and the apparatus is steerable by effecting pivoting of one of the first frame counterpart and the second frame counterpart pivots relative to the other of the first frame counterpart and the second frame counterpart.

In another aspect, there is provided an apparatus for releasably coupling a second trailer to a first trailer that is releasably coupled to a towing vehicle in a tractor-trailer vehicle configuration, the apparatus comprising: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; a kinetic energy recovery device adapted to recover energy from regenerative braking of at least one wheel of the front pair of wheels and the rear pair of wheels; wherein the first trailer connector assembly, the second trailer connector assembly, at least one wheel, and the kinetic energy recovery device are cooperatively configured such that while the first trailer translates with the towing vehicle, and the releasable coupling of the apparatus to the first trailer and to the second trailer is effected, braking by the towing vehicle is with effect that the kinetic energy recovery device converts kinetic energy generated by rotation of the at least one of the wheels to recoverable energy; and the apparatus is steerable by effecting pivoting of one of the first frame counterpart and the second frame counterpart pivots relative to the other of the first frame counterpart and the second frame counterpart.

In another aspect, there is provided an apparatus for releasably coupling a second trailer to a first trailer that is releasably coupled to a towing vehicle in a tractor-trailer vehicle configuration, the apparatus comprising: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; a kinetic energy recovery device operably coupled to at least one wheel of the front pair of wheels and the rear pair of wheels for converting mechanical energy generated by rotation of the at least one wheel to recoverable energy; and an energy storing device operably connected to the kinetic energy recovery device for storing recoverable energy generated by the kinetic energy recovery device; wherein the first trailer connector assembly, the second trailer connector assembly, the at least one wheel, the kinetic energy recovery device, and the energy-storing device are co-operatively configured such that while the first trailer translates with the towing vehicle and the releasable coupling of the apparatus to the first trailer and to the second trailer is effected, and the towing vehicle is decelerating, the kinetic energy recovery device converts the mechanical energy to recoverable energy, which is stored on the energy storing device; and the apparatus is steerable by effecting pivoting of one of the first frame counterpart and the second frame counterpart pivots relative to the other of the first frame counterpart and the second frame counterpart.

In another aspect, there is provided an apparatus for releasably coupling a second trailer to a first trailer that is releasably coupled to a towing vehicle in a tractor-trailer vehicle configuration, the apparatus comprising: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; a kinetic energy recovery device adapted to recover energy from regenerative braking of at least one wheel of the front pair of wheels and the rear pair of wheels; an energy-storing device electrically connected to the kinetic energy recovery device for storing the energy generated by the regenerative braking; wherein the energy-storing device is disposed intermediate the first trailer connector assembly and the second trailer connecting assembly; and the apparatus is steerable by effecting pivoting of one of the first frame counterpart and the second frame counterpart pivots relative to the other of the first frame counterpart and the second frame counterpart.

In another aspect, there is provided an apparatus for releasably coupling a second trailer to a first trailer that is releasably coupled to a towing vehicle in a tractor-trailer vehicle configuration, the apparatus comprising: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; a kinetic energy recovery device adapted to recover energy from regenerative braking of at least one wheel of the front pair of wheels and the rear pair of wheels, comprising: at least one motor-generator operably coupled to the at least one wheel, wherein the at least one motor-generator is operable in: a drive mode for applying motive rotational force to the at least one wheel; and a generator mode for converting the kinetic energy to recoverable energy, the generator mode effecting deceleration of the at least one wheel; an energy storing device for storing the recoverable energy; and a controller operably coupled to the at least one motor-generator for selectively activating the drive mode or the generator mode; wherein the first trailer connector assembly, the second trailer connector assembly, the at least one wheel, and the kinetic energy recovery device are cooperatively configured such that while the first trailer translates with the towing vehicle, and the releasable coupling of the apparatus to the first trailer and to the second trailer is effected, braking by the towing vehicle is with effect that the kinetic energy recovery device converts kinetic energy generated by rotation of the at least one wheel to recoverable energy; and the apparatus is steerable by effecting pivoting of one of the first frame counterpart and the second frame counterpart pivots relative to the other of the first frame counterpart and the second frame counterpart.

In another aspect, there is provided a tractor-trailer vehicle, comprising: a towing vehicle; a first trailer releasably coupled to the towing vehicle such that the first trailer translates with the towing vehicle; a dolly apparatus releasably coupled to the first trailer such that the dolly apparatus translates with the first trailer; and a second trailer releasably coupled to the dolly apparatus such that the second trailer translates with the dolly apparatus; wherein the dolly apparatus includes: a first frame counterpart and a second frame counterpart that are pivotably connected to define a frame; a first trailer connector assembly disposed on the first frame counterpart for releasably coupling the apparatus to the first trailer such that the apparatus translates with the first trailer; a second trailer connector assembly disposed on the second frame counterpart for releasably coupling the apparatus to the second trailer such that the second trailer translates with the apparatus; a front pair of wheels rotatably coupled to the first frame counterpart; a rear pair of wheels rotatably coupled to the second frame counterpart; a kinetic energy recovery device adapted to recover energy from regenerative braking of at least one wheel of the front pair of wheels and the rear pair of wheels; and the releasable coupling of the apparatus to the second trailer is with effect that the second trailer overlaps the dolly apparatus by a length that is less than an overall length of the second trailer; and the apparatus is steerable by effecting pivoting of one of the first frame counterpart and the second frame counterpart pivots relative to the other of the first frame counterpart and the second frame counterpart.

In another aspect, there is provided an apparatus for towing trailers, the apparatus comprising: a first frame counterpart and a second frame counterpart; wherein: the first frame counterpart is connected to the second frame counterpart such that a frame is defined; and the connection includes a pivotable connection; a trailer connector disposed on the second frame counterpart for releasably coupling to a trailer such that the trailer is translatable with the apparatus; a plurality of wheels distributed amongst the first and second frame counterparts, wherein each one of the wheels, independently, is coupled to a one of the first and second frame counterparts; wherein the first frame counterpart, the second frame counterpart, and the wheels are co-operatively configured such that: (i) the frame is supported above a reaction surface by the wheels; and (ii) the frame is moveable across the reaction surface in response to rolling movement of the wheels; an energy storage device; an actuator; a drive system operable in a drive mode; a controller for selectively activating the drive mode of the drive system; wherein: the first frame counterpart, the second frame counterpart, the actuator, the drive system, the energy storage device, and the controller are co-operatively configured such that, the drive mode is activatable by the controller with effect that communication between the energy storage device and the drive system is established such that the drive system stimulates the actuator to urge pivoting of one of the first frame counterpart and the second frame counterpart relative to the other of the first frame counterpart and the second frame counterpart.

In another aspect, there is provided a kit for an apparatus for towing trailers, the apparatus comprising: a first frame counterpart and a second frame counterpart; wherein: the first frame counterpart is connectible to the second frame counterpart such that a frame is defined; and the connection includes a pivotable connection; a trailer connector disposable on the second frame counterpart for releasably coupling to a trailer such that the trailer is translatable with the apparatus; a plurality of wheels distributable amongst the first and second frame counterparts, wherein each one of the wheels, independently, is couplable to a one of the first and second frame counterparts; wherein the first frame counterpart, the second frame counterpart, and the wheels are co-operatively configured such that: (i) the frame is supportable above a reaction surface by the wheels; and (ii) the frame is moveable across the reaction surface in response to rolling movement of the wheels; an energy storage device; an actuator; a drive system operable in a drive mode; a controller for selectively activating the drive mode of the drive system; wherein: the first frame counterpart, the second frame counterpart, the actuator, the drive system, the energy storage device, and the controller are co-operatively configured such that, while the first frame counterpart is pivotably coupled to the second frame counterpart, and while the plurality of wheels are independently coupled to the one of the first and second frame counterparts, the drive mode is activatable by the controller with effect that communication between the energy storage device and the drive system is established such that the drive system stimulates the actuator to urge pivoting of one of the first frame counterpart and the second frame counterpart relative to the other of the first frame counterpart and the second frame counterpart.

Other example aspects will be apparent from the disclosure and drawings provided herein.

### BRIEF DESCRIPTION OF DRAWINGS

For a more complete understanding of the present example embodiments, and the advantages thereof, reference is now made to the following description taken in conjunction with the accompanying drawings, in which:

FIG. 1 is a side view of a tractor-trailer including an active converter dolly;

FIG. 2A is a perspective view of another embodiment of an active converter dolly;

FIG. 2B is a schematic diagram of one embodiment of a kinetic energy recovery device for an active converter dolly;

FIG. 3 is a perspective view of the active converter dolly;

FIG. 4 is a perspective view of a battery enclosure of the active converter dolly;

FIG. 5A is a schematic view of an active converter dolly control system;

FIG. 5B is a flowchart outlining one embodiment of controlling an active converter dolly;

FIG. 5C is a flowchart outlining one embodiment of transmitting signals from the converter dolly control system;

FIG. 6 is a schematic diagram of another embodiment of an active converter dolly for use with a tractor-trailer;

FIG. 7 is a chart outlining motor motive rotational force vs. throttle;

FIG. 8 is a chart outlining showing regenerative and friction brake motive rotational force blending;

FIG. 9A is a chart outlining engine motive rotational force vs engine speed for one active converter dolly operational mode;

FIG. 9B is a chart outlining engine motive rotational force vs engine speed for a second active converter dolly operational mode;

FIG. 10 is a schematic diagram of another embodiment of a kinetic energy recovery device;

FIG. 11 is a schematic diagram of a further embodiment of a kinetic energy recovery device;

FIG. 12 is a schematic diagram of a steering mechanism for use with an active converter dolly apparatus;

FIGS. 13A and 13B are charts outlining turning radius with respect to different active converter dolly apparatus configurations;

FIG. 14 is a perspective view of another embodiment of an active converter dolly apparatus;

FIG. 15 is a simplified partial rear view of an active converter dolly apparatus with an in-wheel motor configuration;

FIG. 16 is a simplified partial rear view of an active converter dolly apparatus with a differential configuration;

FIG. 17 is a flowchart showing the operation of an example controller of an active converter dolly apparatus operating in a stability-assistance mode;

FIG. 18 is a flowchart showing the operation of an example controller of an active converter dolly apparatus configured with an electric-vehicle mode;

FIG. 19 is a flowchart showing the operation of an example controller of an active converter dolly apparatus configured with an anti-idling mode; and

FIG. 20 is a flowchart showing the operation of an example controller of an active converter dolly apparatus operating in a backup-assistance mode.

FIG. 21 is a perspective view of an alternative embodiment of a one-axle converter dolly.

FIG. 22 is a perspective partial view of the dolly of FIG. 21, looking from underneath the centre of the dolly, facing backward and toward the left wheel.

FIG. 23 is a cutaway version of the view of FIG. 21 showing details of the in-hub motor-generators and batteries.

FIG. 24 is a perspective view of a two-axle converter dolly to which various embodiments may be applied.

FIG. 25 is a bottom view of the two-axle dolly of FIG. 24.

FIG. 26 is a front-left perspective view of an example terminal tractor to which various embodiments may be applied.

FIG. 27 is a back-left perspective view of the terminal tractor of FIG. 26.

FIG. 28A is a side view of an example trailer with a rear pair of wheels driven by a motor and a retractable front wheel in a retracted position, to which various embodiments may be applied.

FIG. 28B is a side view of the example trailer of FIG. 28(a), with the retractable front wheel in an extended position, to which various embodiments may be applied.

FIG. 29 is a perspective view of an example embodiment of an apparatus for towing a trailer.

FIG. 30 is a top view of the apparatus of FIG. 29.

FIG. 31 is another perspective view of the apparatus of FIG. 29.

FIG. 32 is a top view of the apparatus of FIG. 31.

FIG. 33 is another perspective view of the apparatus of FIG. 29.

FIG. 34 is a side view of the apparatus of FIG. 29.

FIG. 35 is a perspective view of another example embodiment of an apparatus for towing a trailer.

FIG. 36 is another perspective view of the apparatus of FIG. 35.

### DETAILED DESCRIPTION

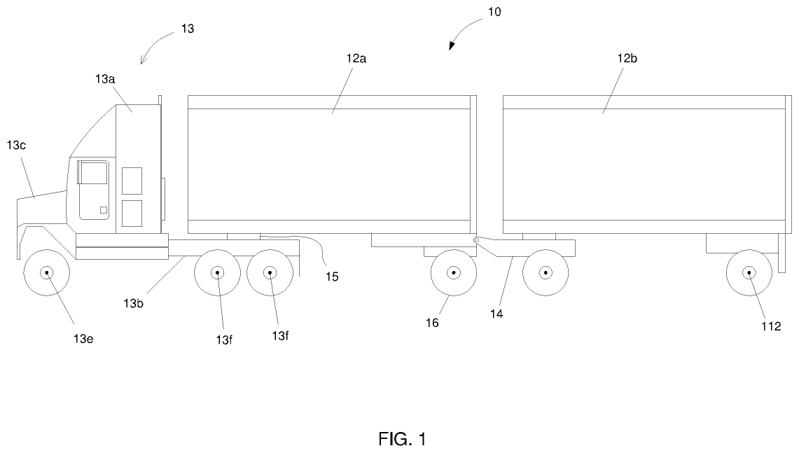

The disclosure is directed at an active converter dolly apparatus for use in a tractor-trailer configuration. More specifically, with reference now to FIGS. 1-20, there is disclosed an apparatus for releasably coupling a second trailer to a first trailer that is releasably coupled to a tractor or towing vehicle in a tractor-trailer vehicle configuration.

In one embodiment, the apparatus includes a system to connect a towing vehicle to a trailer. The apparatus further includes a kinetic energy recovery device for translating the mechanical motions or actions of the dolly into electricity or electrical energy so that this energy can be used to charge an energy storing device such as a battery or to power other functionality for either the dolly or the tractor-trailer.

With reference to FIG. 1, a schematic diagram of a tractor-trailer vehicle configuration incorporating an example embodiment of an active converter dolly apparatus 14 according to the present disclosure is shown.

The tractor-trailer 10 includes a towing vehicle 13, such as a tractor, cab or truck that pulls a pair of trailers 12 (seen as a primary or first trailer 12a and a secondary or second trailer 12b) that are connected to each other via an active convertor dolly apparatus 14. The active convertor dolly apparatus 14 connects the two trailers 12a and 12b together such that they move with respect to each other when the towing vehicle 13 is in motion. While only a pair of trailers 12 is shown, it will be understood that more than one active converter dolly apparatus 14 may be used in combination with additional trailers in instances when a tractor-trailer configuration having more than two trailers is desired. Accordingly, the active converter dolly apparatus 14 disclosed in the subject application is not intended to be limited to use in a tractor-trailer configuration having only primary and secondary trailers.

As shown in FIG. 1, the primary and secondary trailers 12a, 12b are connected to each other via the active convertor dolly apparatus 14. The active convertor dolly apparatus 14 connects the two trailers 12a and 12b such that they move together with the towing vehicle 13 when the towing vehicle 13 is in motion. In some embodiments, for example, the apparatus 14 releasably couples the second trailer 12b to the first trailer 12a, which is releasably coupled to the towing vehicle 13, such that while the first trailer 12a is releasably coupled to the towing vehicle 13 and the towing vehicle 13 is in motion, the apparatus 14 translates with the first trailer 12a and the second trailer 12b translates with the apparatus 14, the apparatus 14, the first trailer 12a, the second trailer 12b and the towing vehicle 13 therefore together forming the tractor-trailer vehicle configuration.

The towing vehicle 13 (sometimes referred to as a prime mover or traction unit) is generally in the form of a heavy-duty towing vehicle having a heavy-duty towing engine that provides motive power for hauling a load. In the subject example embodiment, the towing vehicle 13 has a cab portion 13a and a flatbed portion 13b that extends rearwardly from the cab portion 13a. The cab portion 13a includes an engine compartment 13c and a driver compartment 13d. A front axle 13e is located under the engine compartment 13c and one or more rear axles 13f are located under the flatbed portion 13b of the towing vehicle 13. While in the subject example embodiment the towing vehicle 13 is shown as having only three axles, it will be understood that the actual number axles can vary depending on the actual size of the towing vehicle 13 and the various sizes/types of loads that the towing vehicle 13 is configured for or intended to pull.

In some embodiments, for example, one or more axles on the towing vehicle 13 may be steering axles and one or more axles are driven axles for transmitting motive power from the engine to the wheels 16. Un-driven axles are those that do not receive motive power from the engine but that rotate as a result of the motion induced by the driven axles. In some embodiments, for example, the steering axle(s) may also be driven. In some embodiments, for example, an un-driven rear axle can be raised such that the wheels mounted thereon are no longer in contact with the ground or roadway in instances when the towing vehicle 13 is lightly loaded or is not coupled to a trailer so as to save wear on the tires/wheels and/or increase traction on the wheels/tires associated with the driven axle(s).

Trailers 12a, 12b typically have no front axle and one or more un-driven rear axles 112. In some embodiments, for example, the rear axles 112 of trailers 12a, 12b are fixed axles and, in some example embodiments, the rear axles 112 may be part of a slider unit (not shown) that is mounted underneath the trailer 12a, 12b which allows the rear axles 112 to be moved forward or backward, in accordance with principles known in the art, depending on the load being carried by the trailer 12.

In the subject example embodiment, the primary trailer or first trailer 12a is supported by the flatbed portion 13b of the towing vehicle 13. In some embodiments, for example, in order to couple the first trailer 12a to the towing vehicle 13, the flatbed portion 13b is provided with a coupling plate 15, commonly referred to as a fifth wheel coupling, configured for receiving and coupling with a corresponding locking pin, or kingpin, (not shown) that extends from underneath the first trailer 12b which is received within a corresponding slot formed in the coupling plate 15, the first trailer 12b resting and pivoting on the coupling plate 15 about the locking pin. While a fifth wheel coupling has been described in connection with the coupling of the first trailer to the towing vehicle 13 it will be understood that various other couplings may be used provided the coupling between the towing vehicle 13 and the first trailer 12a is such that the first trailer translates with the towing vehicle 13 when the towing vehicle 13 is in motion and can pivot relative to the towing vehicle 13 for maneuverability. The coupling of the first trailer 12a to the towing vehicle 13 also includes the coupling of at least brake lines to transmit braking forces to the wheels 16 of the trailer 12a when the driver applies the tractor brakes. The coupling of the first trailer 12a to the towing vehicle 13 also includes the coupling of electrical cable to ensure an electrical connection between the tractor and the first trailer 12a for proper operation of tail lights and any other required auxiliary devices or systems associated with the first trailer 12a.

In the subject example embodiment, the second trailer 12b is coupled to the first trailer 12a by way of the active converter dolly or apparatus 14. Accordingly, the active converter dolly or apparatus 14 includes at least one pair of wheels 22 that act as the front axle of the second trailer 12b and also includes a first trailer connector assembly 7 for releasably coupling the apparatus 14 to the first trailer 12a such that the apparatus 14 translates with the first trailer 12a. A second trailer connector assembly 6 is provided for releasably coupling the apparatus 14 to the second trailer 12b such that the second trailer 12b translates with the apparatus 14 with both the first trailer 12a and the second trailer 12b being towed by the towing vehicle 13. The coupling of the second trailer 12b within the tractor-trailer vehicle configuration also includes the coupling of brake lines and electrical cables to ensure proper operation of the tractor trailer vehicle 10. As set out above, the apparatus 14 is intended to act as the front axle of the secondary trailer 12b with only a portion of the apparatus 14 extending underneath the secondary trailer 12b such that there is a partial overlap of the trailer 12b with respect to the apparatus 14. In some embodiments, for example, the second trailer connector assembly 6 includes a second trailer support surface and the releasable coupling of the apparatus 14 to the second trailer via the second trailer connector assembly 6 is with effect that the second trailer support surface is disposed underneath the second trailer 12b. In some embodiments, for example, the overlap between the secondary trailer 12b and the apparatus 14 is less than 75% of the length of the secondary trailer 12b. In some embodiments, for example, the overlap between the secondary trailer 12b and the apparatus 14 is less than 50% of the length of the secondary trailer 12b. In some embodiments, for example, the overlap between the secondary trailer 12b and the apparatus 14 is less than 25% of the length of the secondary trailer 12b. Different embodiments of the apparatus 14 may have different maximum lengths when measured along an axis of the apparatus 14 that is parallel to its central longitudinal axis. In some embodiments, the maximum length is 15 feet. In other embodiments, the maximum length is 12.5 feet. In other embodiments, the maximum length is 10 feet.

In some embodiments, for example, the active converter dolly or apparatus 14 defines a footprint having an area that is less than 50% of an area defined by an undersurface of the secondary trailer 12b. In some embodiments, for example, the apparatus defines a footprint having an area less than or equal to 50 ft².

In the subject example embodiment, the active converter dolly apparatus 14 includes a kinetic energy recovery device 30 that is adapted to recover energy from regenerative braking of at least one wheel of the at least one pair of wheels 22 wherein the first trailer connector assembly 7, the second trailer connector assembly 6, the at least one wheel 22, and the kinetic energy recovery device 30 are cooperatively configured such that while the first trailer 12a translates with the towing vehicle 13, and the releasable coupling of the apparatus 14 to the first trailer 12a and to the second trailer 12b is effected, braking by the towing vehicle 13 is with effect that the kinetic energy recovery device 30 converts kinetic energy generated by rotation of the at least one wheel 22 to electrical energy. In some embodiments, for example, the first trailer connector assembly 7, the second trailer connector assembly 6, the at least one wheel 22, the kinetic energy recovery device 30 and the energy storing device 32 are cooperatively configured such that while the first trailer 12a translates with the towing vehicle 13, and the releasable coupling of the apparatus 14 to the first trailer 12a and to the second trailer 12b is effected, and the towing vehicle 13 is decelerating, the kinetic energy recovery device 30 converts the mechanical energy to electrical energy, which electrical energy is stored on the energy storing device 32.

Regenerative braking, in general, is an energy recovery mechanism when the mechanical or kinetic energy generated by the rotation of the wheels is recovered or converted into another usable form by applying a regenerative braking force to the wheels, the regenerative braking force effectively slowing down or causing a deceleration in the rotation of the wheels. More specifically, in systems incorporating regenerative braking, an electric motor is used as an electric generator by operating the electric motor in reverse and is therefore often referred to as a motor-generator. The kinetic energy generated by the rotating wheels is transformed into electrical energy by the generator, which electric energy is subsequently stored by an energy storing device 32 such as, for example, a battery. In some embodiments, for example, the energy storing device 32 includes one or more batteries and one or more capacitors. The energy stored on the energy storing device can then be used for other applications.

In some embodiments, for example, the kinetic energy recovery device 30 is a charge-generating system for translating mechanical motion experienced by the apparatus 14 into an electric charge which allows the apparatus 14 to be used for other applications, as set out in more detail below. In some embodiments, the electric charge can be used to charge a battery or other energy storing device. In some embodiments, the electric charge may be used to power auxiliary devices like refrigeration, an HVAC unit, or other climate control system mounted to the tractor-trailer 10 as part of, either, the towing vehicle 13, first trailer 12a, or second trailer 12b. In some embodiments, the charged battery can be used to jumpstart a dead truck battery or to supply power to accessories when the engine of the towing vehicle 13 is off. In some embodiments, the charged battery can be used to provide motive rotational force to the dolly's wheel through one or more motor-generators.

In some embodiments, the controller is configured to detect a jumpstart condition of the dolly apparatus 14. The jumpstart condition may be, for example, a condition/state of an interrupt, a presence of an electrical connection between the energy storing device 32 and a towing vehicle battery, an operating condition of the controller (e.g., software setting or the like), or a combination thereof. The dolly apparatus 14 may be operated to transmit stored energy from the energy storing device via an electrical connection a towing vehicle battery to jumpstart towing vehicle in response to detecting a jumpstart condition of the dolly apparatus 14.

In some embodiments, for example, the active convertor dolly apparatus 14 may be configured to generate charge from other wheels and axles within the tractor-trailer vehicle 10, such as in a series or parallel implementation, to charge the energy-storing device or battery.

In some embodiments, for example, the active convertor dolly apparatus 14 is a through-the-road (TTR) hybrid vehicle as the apparatus 14 is configured to operate independently from the other axles of the trailers 12 of the tractor-trailer vehicle 10 as will be described in further detail below.

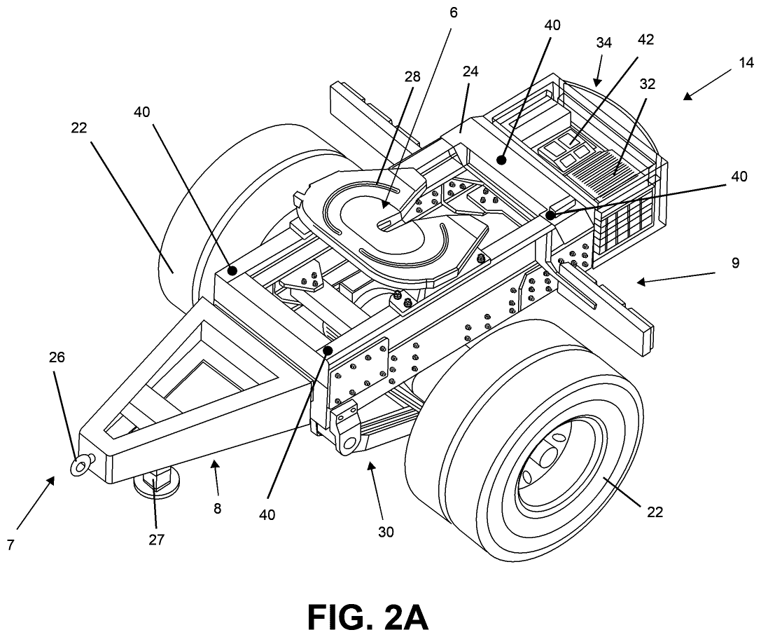

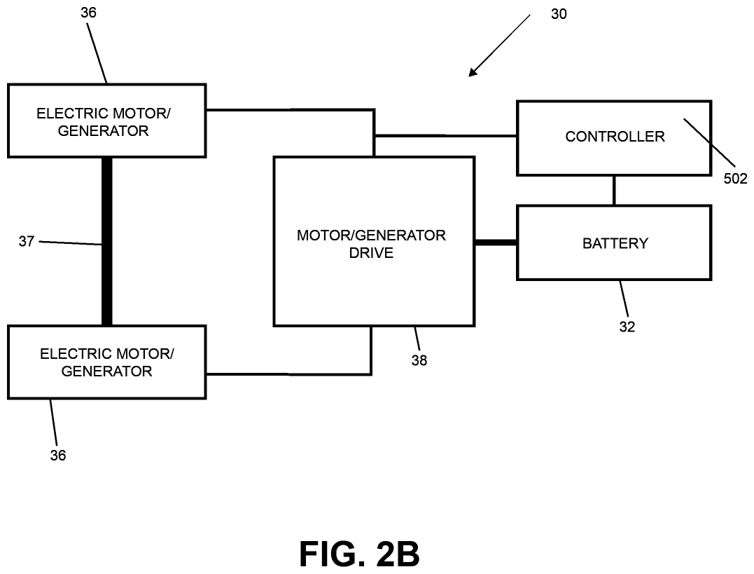

Turning to FIG. 2a, a perspective view of one example embodiment of an active convertor dolly apparatus 14 is shown.

In this example embodiment, the active converter dolly apparatus 14 includes a frame 24 including a wheel supporting portion, or second end, 9 along with a tongue portion, or first end 8. The frame 24 can be manufactured from different materials such as, but not limited to, high strength steel, carbon fibre, aluminum, or other materials. As will be understood, the apparatus 14 does not have to be made entirely from one material and may be a combination of at least two different materials. As will be discussed in more detail below, the lightweight nature of the composite materials may also provide a benefit or advantage in terms of fuel savings. In some embodiments, for example, the frame 24 is made from lightweight composites in combination with metal components when required for strength or reinforcement purposes. Accordingly, in some embodiments, for example the frame 24 includes only a first material wherein the first material is a metal material. In other embodiments, for example, the frame 24 includes a first material and a second material, wherein the first material is a metal material and the second material is a composite material having a weight that is less than the weight of the metal material such that the frame 24 has an overall weight that is less than an overall weight of a frame having only the first, metal material, the reduction in overall weight of the frame contributing to an increase fuel efficiency of the tractor-trailer vehicle.

A first trailer connector assembly 7, which in the current embodiment can be seen as a hitch 26, forms part of a tongue portion located at a first end 8 of the frame 24 for connecting the converter dolly apparatus 14 to the first trailer 12a. The connection between the first trailer 12a and the converter dolly apparatus 14 will be well understood by one skilled in the art. Although not shown, the first end 8 of the frame 24 may also include safety chains and at least one electrical connection 72, such as a wiring harness connection for enabling or securing the first trailer 12a to the apparatus 14. The electrical connection 72 is capable of delivering power from the trailer 12a to the apparatus 14, and in some embodiments for providing power and/or data signals from the apparatus 14 to the first trailer 12a. This electrical communication may extend through the first trailer 12a to the towing vehicle 13, and it may be mediated at one or more points by further converters or transformers, such as a DC-DC (direct current-direct current) converter or transformer for stepping down the high-voltage power stored in the energy storage device of the apparatus 14 to the low-voltage electrical systems of the towing vehicle 13. In some embodiments, the electrical connection 72 includes electrical connection of the kinetic energy recovery device 30 to the first trailer 12b for receiving vehicle data from the towing vehicle 13.

In some embodiments, a support leg or support apparatus 27 is also attached to the frame 24 at the first end 8. In some embodiments, for example, the support leg or apparatus 27 includes a coaster wheel.

The apparatus 14 has a second end 9 at the rear of the frame 24. The frame 24 includes at least one pair of wheels 22 rotatably mounted to the frame 24. For each one of the at least one pair of wheels 22, one of the wheels of the pair of wheels 22 is mounted on one side of the frame 24 and the other one of wheels of the pair of wheels 22 is mounted to a second opposite side of the frame 24. Each one of the wheels 22, independently, is disposed on opposite sides of a central longitudinal axis of the apparatus 14 (i.e. from front first portion 8 to rear second portion 9) and configured for rotation about an axis transverse to, or substantially transverse to, the central longitudinal axis of the apparatus (such as the axis from the left side to the right side of the frame 24). In the illustrated embodiment, the wheel pairs includes two wheels 22 to improve the load bearing capacity of the active converter apparatus 14.

In some embodiments, for at least one (for example, each one) of the at least one pair of wheels 22, the wheels are mounted to an axle. In some embodiments, the axle is rotatably coupled to the frame 24. In some embodiments, for example, the axle is a single solid shaft (e.g. driveshaft) and each one of the wheels 22 of the pair, independently, is rotatably coupled to the same shaft, such that the axle includes, or is defined by, the single solid shaft, and the single solid shaft is driven by a motor. In some embodiments, for example, each one of the wheels 22 of the pair, independently, is coupled to a respective shaft (e.g. driveshaft), such that one of the wheels of the pair is rotatably coupled to a first driveshaft and the second one of the wheels of the pair is rotatably coupled to a second driveshaft, and the first and second driveshafts are coupled to each other via a differential, such that the axle includes, or is defined by, the first driveshaft, the second driveshaft, and the differential. In some embodiments, for at least one (for example, each one) of the at least one pair of wheels 22, each one of the wheels of the pair, independently, is mounted to the frame 24 via a non-rotating shaft and is driven by a respective driveshaft (and each one of the wheels of the pair is coupled to its own electric motor-generator wheel assembly via its own driveshaft). In this respect, a first wheel on the left side of the frame 24 may be connected to a first driveshaft 110, and a second wheel on the right side of the frame 24 may be connected to a second driveshaft 111, and there is an absence of interconnection between the first and second driveshafts 110, 111, and such that such that the axle includes, or is defined by, the independent first and second driveshafts 110, 111. In some embodiments, each one of the wheels of the pair, independently, is mounted to the frame 24 via a non-rotational shaft and is coupled to its own electric motor-generator wheel assembly (e.g. via a driveshaft), such that the axle includes, or is defined by, the non-rotational shaft.

In the illustrated embodiment of FIG. 2a, a secondary trailer mounting assembly 6 is shown as a fifth wheel assembly 28 that is mounted to a top of the frame 24. The fifth wheel assembly 28 may include an upwardly facing portion having a slot for receiving a corresponding protrusion (or locking pin or kingpin) from the secondary trailer 12b for removable mounting or coupling of the secondary trailer 12b to the converter dolly apparatus 14. The fifth wheel assembly 28 is supported in some embodiments by a spring suspension system (not shown). In some embodiments, for example, the spring suspension system is for dampening displacement of the second trailer 12b along an axis perpendicular to, or substantially perpendicular to, the central longitudinal axis of the apparatus 14.

As set out above, the apparatus 14 includes a kinetic energy recovery device 30 or a charge generating system that generates an electric charge during certain mechanical actions by the apparatus 14. The electric charge in some embodiments is used to charge an energy-storing device 32, such as a battery, that is mounted to the frame 24. In some embodiments, for example, the energy-storing device 32 is housed within an enclosure or housing 34 to protect the energy-storing device 32 from any damage. In some embodiments, for example, the enclosure 34 is waterproof and durable.

A schematic diagram of the kinetic energy recovery device 30 or charge generating system is shown in FIG. 2b.

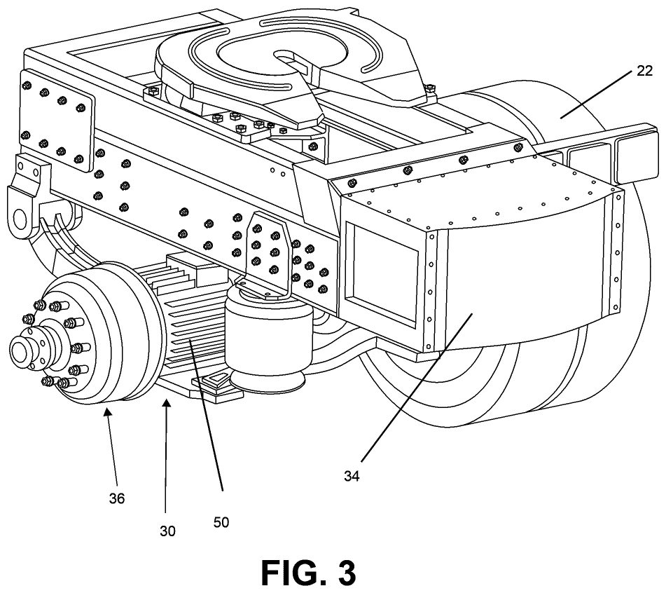

As schematically shown in FIG. 2b, the kinetic energy recovery device 30 includes a set of one or more electric motor-generators 36 (two in the example embodiments of FIGS. 2a and 3), mounted to an electric axle 37 that connects the wheels 22 (as shown in FIG. 2a). The motor-generators 36 are used to convert the electric energy stored in the energy-storing device 32 to mechanical energy by applying a motive rotational force to the wheels 22 thereby rotating the wheels 22 (drive mode), or to convert mechanical energy from the rotating wheels 22 into electric power (generator mode) by applying a regenerative braking force to the wheels 22 thereby braking or effecting deceleration of the wheels 22. In the example embodiments of FIGS. 2a, 2b, and 3, the electric motor-generators 36 are located proximate the wheels 22 of the apparatus 14. In some embodiments, for example, each wheel 22 includes a hub wherein the electric motor generators 36 are mounted within the respective hub of the wheels 22. Although two motor-generators 36 are shown, it will be understood that the kinetic energy recovery device 30 may include only a single motor-generator (such as located along the axle between the two wheels 22 through a differential 116) or may include more than two motor-generators 36. The motor-generator 36 controls the movement of the wheels 22 via the axle 37 based on signals transmitted from a dolly controller 502. The controller 502 will be described in more detail below.

The energy-storing device 32 stores energy generated by the kinetic energy recovery device 30. In some embodiments, a motor-generator drive 38 receives the electric power generated through regenerative braking of the apparatus 14 to charge the energy-storing device 32; the motor-generator drive 38 can later use this stored power to power the electric motors 36. In some embodiments, kinetic energy may be converted into electric form by regenerative braking when the truck's engine is running at high efficiency and the battery is at low charge.

The active converter dolly apparatus 14 may further include a plurality of onboard instrumentation within a control system or controller 502 that communicate with equipment, such as sensors 40, that may be used for, among other applications, assistance with steering and stability. In some embodiments, the sensors 40 may be used to assist in aligning the first and second trailers 12a and 12b when the tractor-trailer 10 is moving in reverse. In some embodiments, the sensors 40 may be used to detect low-traction conditions and stabilize the vehicle in motion. These applications are set out in further detail below.

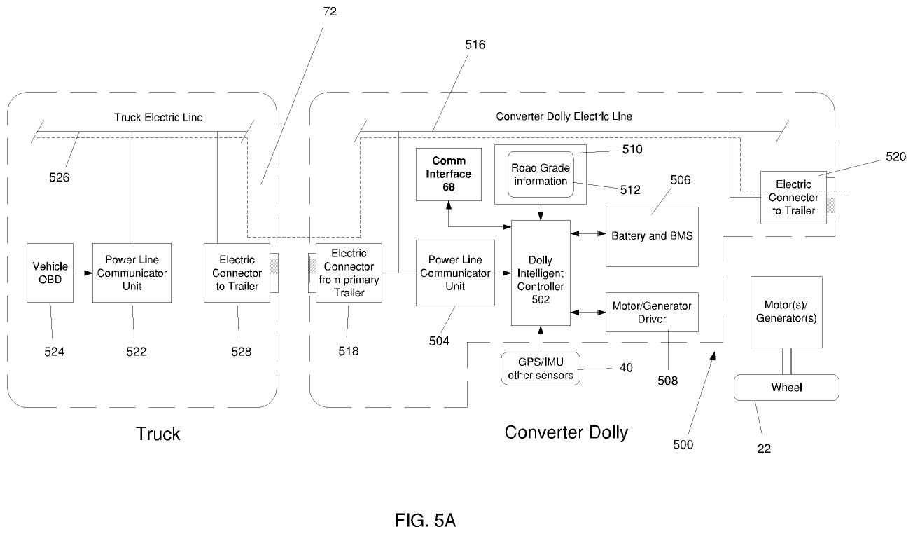

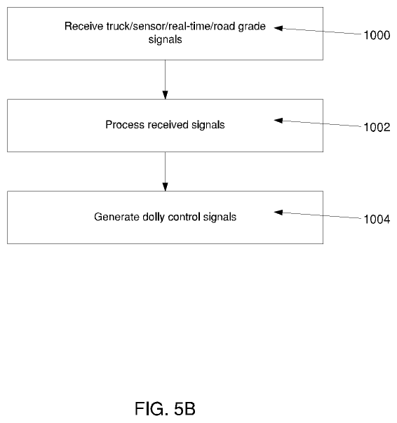

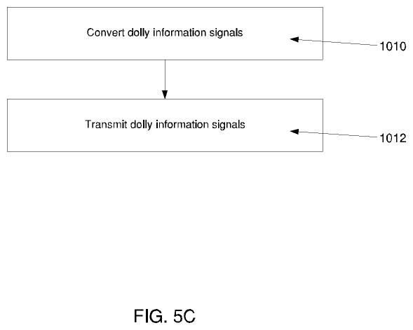

Furthermore, in some embodiments, sensors may be used to help identify the relative position of the converter apparatus 14 to other elements or components of the tractor-trailer 10. The output from the sensors 40 can be fed into one or more dolly control systems (located within the enclosure 34 in some embodiments), when such information can be used to control the apparatus 14. (A schematic diagram of a dolly control system is shown and described in more detail below with respect to FIG. 5.)

FIG. 3 is a schematic rear view of the dolly of FIG. 2a. Some components of the dolly have been removed for ease of understanding of the disclosure. For instance, one set of wheels 22 and parts of the frame 24 have been removed.

In some embodiments, for example, the kinetic energy recovery device 30 includes an electric motor-generator wheel assembly 50 that can be seen as an integrated electric motor wheel assembly. Although not shown, a similar wheel assembly is preferably mounted adjacent the other wheel 22. These two electric motor-generator wheel assemblies 50 may in various embodiments include two motor-generators 36 driving two axles (one for the wheels 22 on each side of the frame 24), one or more motor-generators 36 driving a differential 116 attached to two drive shafts 110, 111, or one or more motor-generators 36 driving a single common axle attached to the wheels 22 on both sides of the frame 24.

In operation, as the tractor-trailer 10 starts to brake, the motor-generator wheel assembly 50 captures the kinetic energy of the apparatus 14, with this energy flowing via the motor-generator drive 38 to the energy-storing device 32. The combination of electric motor-generators 36 and drive 38 converts the kinetic energy into electricity before it is transmitted to the energy-storing device 32.

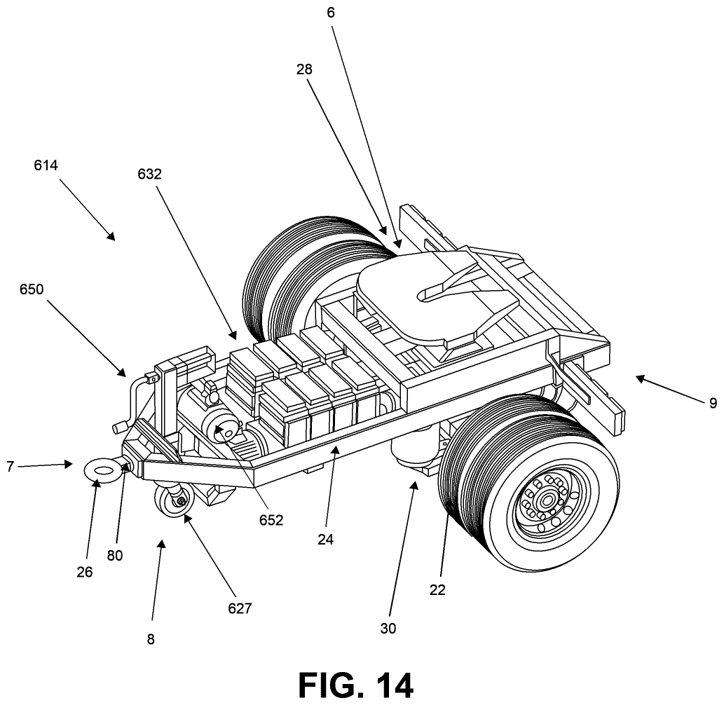

In some embodiments, braking of the tractor-trailer vehicle 10 is detected through the brake lines and/or the electrical connection 72 from the towing vehicle 13 to the dolly apparatus 14. In other embodiments, this method of braking detection may be replaced or supplemented with one or more sensors incorporated into the apparatus 14 to detect acceleration and deceleration and to operate the drive mode and generator mode of the motor-generators 36 accordingly. For example, some embodiments may eliminate the need for real time braking data from the towing vehicle 13 by incorporating one or more force sensors into the dolly 14. The force sensors may be strain gauges and/or load cells to sense the pull/push forces. The force sensors may be located somewhere on the frame 24, on the second trailer connector assembly 6, or on the first trailer connector assembly 7. In the example embodiment shown in FIG. 14, force sensors 80 such as strain gauges are incorporated into the pintle hook or hitch 26 forming the first trailer connector assembly 7. These force sensors 80 are configured to detect compression and tension in the hitch 26, corresponding generally to braking (deceleration) and acceleration of the tractor-trailer 10. When the converter dolly 14 is being “pulled” (e.g. when the hitch is under tension), the motor-generator 36 will apply tractive motive rotational force or motive rotational force to reduce the pull force (drive mode), hence assisting the towing vehicle 13 engine to pull the trailer load. On the other hand, when the converter dolly is being “pushed” (e.g. when the hitch 26 is under compression), the motor-generator 36 will be in the regenerative braking mode (generator mode) to reduce the “push force”, thus harvesting the kinetic energy of the trailer during braking. A close-loop PID controller can be used in some embodiments to minimize the “pull” or “push” force at the force sensors 80 by fine-tuning the PID coefficients. Additionally, some embodiments may use two additional force sensors 80 on left and right sides of the converter dolly's pintle hook or hitch 26 to measure the force vector acting on the electric converter dolly 14. The force vector will provide left or right direction vector information in addition to knowing whether the converter dolly is being “pulled” or “pushed”. The pintle hook or hitch 26 with the load cell sensors 80 may in some embodiments be designed as a replaceable component, to allow ease of replacement in the case of broken sensors. In some embodiments, such a control system will not require any information from the towing vehicle 13, thus allowing the electric converter dolly 14 to be a complete standalone unit.

A battery and control enclosure 34 is mounted on the frame 24. In various embodiments, it may be mounted to the frame 24 on the sides, the rear second end 9 as shown in FIG. 2a, or close to the front first end 8 as described below with respect to the embodiment of FIG. 14. The control enclosure 34 may be formed from a durable waterproof and corrosion resistant material such as a composite or aluminum, which may be lightweight for fuel economy reasons. By being both waterproof and corrosion resistant, the enclosure 34 in some embodiments provides a durable compartment for the converter apparatus 14.

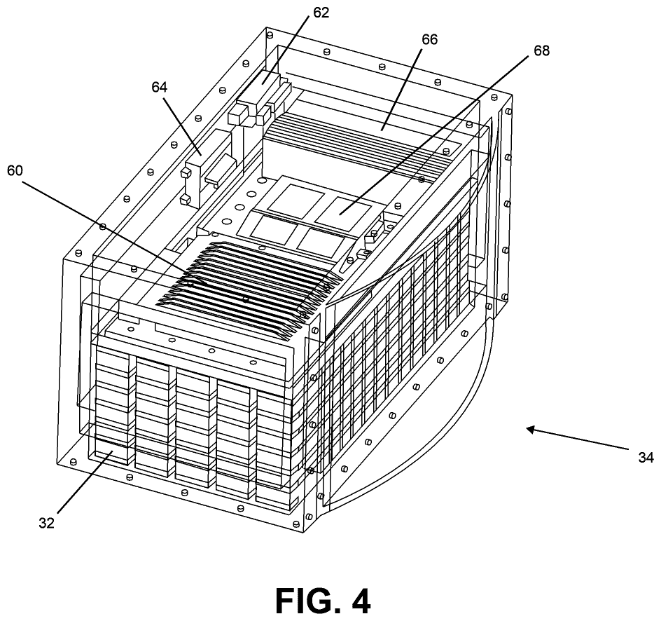

Turning to FIG. 4, a perspective view of one embodiment of a battery enclosure 34 is shown. As illustrated, the walls of the enclosure 34 are shown as being transparent so that the contents of the enclosure can be seen.

In this embodiment, the enclosure 34 houses a control module 60 and an energy-storing device 32 (shown here as a battery). The control module 60 may in various embodiments performs multiple functions for the apparatus 14. In some embodiments, the control module 60 is used to monitor and control the energy-storing device 32. It can also be used to control the motor-generators 36 through their drives 38 in both drive mode and generating mode. Furthermore, the control module 60 may monitor and control the charging of the energy-storing device 32, such as via external plug-in sources. The control module 60 may also include an intelligent power dispatch system to determine when to power the wheels via the motor-generators 36. Furthermore, the control module 60 may include an intelligent steering system to control braking and traction of opposite wheels, or to provide shunting operation of the active converter dolly, or both. In some embodiments, the control module 60 may be used to set up the kinetic energy recovery device 30 for regenerative braking or for providing auxiliary power depending upon the road circumstances and the condition of the load on the tractor engine. The operation of the controller in various embodiments is described in greater detail below.

In some embodiments, for example, the enclosure 34 also houses the energy-storing device 32, which in the preferred embodiment is a modular lithium-ion battery system. The enclosure 34 may also house a sensor interface 62, which communicates with the sensors 40 located throughout the dolly. The sensor interface 62 may communicate with the sensors 40, to assist, for example, with using the apparatus 14 to direct the steering of the trailer(s) when the tractor trailer is moving in reverse. While shown separately, the sensor interface 62 can be integrated within the control module 60.

In some embodiments, the enclosure 34 may also house a gyroscope sensor 64 attached to the frame 24 and an off-board power interface 66. The gyroscope sensor 64 may be in communication with the dolly control system to transmit signals, which can be used, for example, as part of a self-balancing control system for the converter dolly apparatus 14. In some embodiments, for example, the controller 502 may receive and process the signals from the gyroscope sensor 64 and use self-balancing data from the signals (e.g. data on the angular pitch acceleration of the apparatus 14 about a left-to-right central axis of the apparatus 14) to drive the motor-generators 36 to control rotation of the wheels 122 to maintain the level orientation of the apparatus 14 in a self-balancing mode. In the event that the apparatus 14 is self-balancing, the presence of a support leg or support apparatus 27 may not be necessary.

The off-board power interface 66 may be used to connect the energy-storing device 32 to off-board charging systems or off-board loads. The enclosure 34 may include a communication interface 68 that communicates with towing vehicle engine information system. In some embodiments, the communication interface 68 is part of the control module 60. It may in various embodiments be a wired electrical or a wireless communication interface, such as a radio interface (using a wireless protocol such as e.g. 802.11), and it may communicate with the towing vehicle 13 via the tractor's on-board diagnostics (OBD-II) port. The communication interface 68 may in some embodiments be able to access controller area network (CAN) bus data from the towing vehicle 13. In some embodiments, the communication interface 68 may be able to send data from the apparatus 14 to the towing vehicle 13, such as control signals used to control vehicle systems in the towing vehicle 13.

The communication interface 68 may be configured to receive various types of data from the towing vehicle 13, and in some embodiments from the first trailer 12a as well. This data may include the throttle level of the main tractor; the engine motive rotational force; the engine speed; the parking brake state; the transmission state; the brake activation state, or any other information accessible in the towing vehicle 13. This data may, in various embodiments, be used by the active converter dolly control system to determine when to recover, and when to expend, recovered energy to assist in increasing the fuel economy of the tractor-trailer system.

In some embodiments, a forward exterior surface of the battery enclosure 34 may be configured to reduce drag. Various aerodynamic profiles can be used, and the profile shown in FIG. 3 is not intended to be limiting. In some cases, the low positioning of the battery enclosure may allow for a ground effect design to be employed, meaning that the shape will take into account both the passage of air from in front and past the leading edge, as well as air passing below the leading edge between the leading edge and the ground. In some embodiments, for example, the enclosure 34 may also house a cooling system for cooling the energy-storing device 32 and the other electronic components housed within the enclosure 34. In some embodiments, for example, the cooling system is liquid cooled, while in others it is air cooled. In some embodiments, the enclosure 34 is located at a low level between the wheels 22 such that the weight of the battery and control systems within the enclosure 34 are located as low down as is practical to have a lower centre of gravity to improve road handling and control of the apparatus 14 during transport. Accordingly, in some embodiments, the housing or enclosure 34 is disposed on or mounted to the frame such that the apparatus has a centre of gravity disposed below a central, midline axis of the apparatus. In another embodiment, the system may include a lightweight composite chassis or frame 24, which is aerodynamic by design and includes one or more enclosures 34 for the batteries and controls.

Turning to FIG. 5a, a schematic diagram of a control system 500 for the apparatus 14 is shown. In the illustrated embodiment, certain components of a second trailer 12b, which are in communication with the apparatus control system 500, are also schematically shown.

The apparatus control system 500 includes an intelligent controller 502, which is, in some embodiments, implemented within a central processing unit (CPU). In the illustrated embodiment, the controller 502 is in communication with the tractor OBD (on-board diagnostics) unit, such as an OBD-II port, via a power line communicator unit 504 to receive the tractor or truck (e.g. tractor, truck, car or cab) and tractor engine information. Wireless communication, such as a radio-based communication interface, can also be used instead of or in addition to the power line communicator unit 504 to connect the tractor OBD to the dolly control system 502. The dolly control system 502 may also communicate information to the towing vehicle 13 via the communication interface 68 in some embodiments.

The dolly control system 502 also communicates with the set of sensors 40, such as but not limited to, a global navigation satellite system (GNSS) tracking devices, such as global positioning system (GPS) transceiver, an Inertial Measurement Unit (IMU) sensor, one or more wheel speed sensors 70, 71 each placed on one of the wheels 22 or axles of the apparatus 14, one or more linear accelerometers 74, and/or the gyroscope sensor 64. The wheel speed sensors 70, 71 measure individual wheel speeds of the dolly apparatus 74 to capture magnitude and direction (e.g., forwards or backwards) of the dolly apparatus 74, as described elsewhere herein. The gyroscope sensor 74 and the linear accelerometer 74 may be mounted onto the frame 24 around the center of the dolly apparatus 74. The gyroscope sensor 64 may be used to monitor angular acceleration of the dolly apparatus 74 and the linear accelerometer 74 will be used to sense the linear acceleration of the dolly apparatus 74 as described elsewhere herein, as described elsewhere herein.

The intelligent controller 502 may use the sensor data to trigger a corrective response. The wheel speed sensors 70, 71 monitor individual wheel speeds and may trigger the corrective response when the difference of the wheel speed is larger than a preset threshold, as described elsewhere herein. This may occur when one wheel is slipping and spinning much faster than the other wheel on the same axle. This scenario indicates the vehicle is losing traction and in most cases losing control. The accelerometer 74 combined with the gyroscope sensor 64 monitor the linear and angular acceleration of the dolly apparatus 74. When the vehicle is moving forward (i.e., longitudinal direction), a sudden increase in the angular acceleration around the vertical z-axis (i.e., yaw motion) may trigger a corrective response.

The intelligent controller 502, in the case of one motor drive system, connects to a differential and transfers power to the two wheels. When slipping of the wheels or a sudden increase of yaw acceleration are detected, an electronic locking device wheel will lock the differential drive, effectively turning it into a solid axle. This action will transfer the motive rotational force to the wheel with traction, thereby reducing the instability of the dolly apparatus 74. Additionally, when slipping of the wheels occurs, the intelligent controller 502 will cut power to the motor to reduce the motive rotational force output to the wheels.

In the case of independent wheel motors drive system, individual wheel speed and motive rotational force will be controlled by the intelligent controller 502. When a wheel slipping occurs, the intelligent controller 502 will control the speed of the wheels via motive rotational force command to match the corresponding vehicle speed. When a sudden yaw acceleration occurs, the intelligent controller 502 will adjust the motive rotational force applied to the wheel in the opposite direction to counter the detected yaw acceleration, thereby reducing the overall yaw acceleration of the dolly apparatus 74.

When the speed difference of both wheels on the same axle and/or the yaw acceleration of the dolly apparatus 14 is reduced to the preset threshold, the intelligent controller 502 will stop applying the corrective motor response.

The intelligent controller 502 is also in two-way communication with a battery and battery management system (BMS) unit 506 and a motor-generator drive 508 in some embodiments. The battery and BMS unit 506 is also connected to the drive 508. The motor-generator drive 508 is further connected to, or in communication with, the set of motor-generators 36 (see FIG. 2b) that are associated with an individual wheel 22. As schematically shown in FIG. 2b, the number of motor-generators 36 in the illustrated set is two.

The intelligent controller 502 is also connected to a database 510 including road grade information 512, which can be stored within a database or based on sensor information, or real time road information, by connecting the dolly intelligent controller 502 to wireless network.

Separate connectors, seen as an electric connector from the trailer 518 and an electric connector to the trailer 520 are also connected to the electric line 516. As will be understood, one of the connectors 518 or 520 is connected to the first trailer and the other connector is connected to the second trailer.

The intelligent controller 502 may in some embodiments further include an interface of a module allowing the controller to be monitored by a user over the Internet, such as via the communication interface 68.

The truck or tractor includes a power line communication unit 522 that converts information from a vehicle on-bard diagnostics (OBD) system 524 to be sent via the truck electric lines. In another embodiment, the OBD information can be converted and transmitted wirelessly, such as via the communication interface 68. The truck or tractor power line communication unit 522 is connected to the electric line 526 which, in turn, is connected to an electric connector to a trailer 528, In use, the electric connector to trailer 528 and the electric connector from trailer 518 are connected via a cable to each other to deliver power and OBD information from the truck to all the connected trailers and dollies to the tractor.

Collectively, the electric connector from the trailer 518, electric connector to the trailer 520, electric line 516, electric line 526, and electric connector to a trailer 528 shown in FIG. 5 all form part of the electrical connection 72 configured in various embodiments to carry information, or electrical power, or both between the various tractor-trailer vehicle 10 components (i.e. the towing vehicle 13, the first trailer 12a, the dolly apparatus 14, and the second trailer 12b).

In some embodiments, the transmission of signals between the vehicle OBD 524 and the intelligent controller 502 is via the electric line when the signals from the vehicle OBD are converted by the power line communicator unit 522, which then uploads the converted signal to the truck electric line. At the dolly end, the signals are received by the power line communication unit 504 which then extracts the converted OBD signals and then decrypts or converts these signals into a format understood by the controller 502. In another embodiment, the signals may be communicated or transmitted wirelessly between the vehicle OBD and the intelligent controller using the communication interface 68.

In operation, as the tractor-trailer is in motion, the intelligent controller 502 receives and transmits signals to the other components of the controller system. For instance, the intelligent controller 502 can communicate with the sensors 40 to receive signals representing various data that the controller 502 can use to assist in improving operation of the tractor-trailer and the dolly.

A method of convertor dolly control is shown with respect to FIG. 5b. As the truck is driving, the vehicle OBD 524 collects various truck information with respect to characteristics of the truck. For instance, this information may include, but is not limited to, a position of the brake pedal or braking motive rotational force, amount of motive rotational force being generated by the engine, the speed of the engine, etc. The sensors may also collect sensor information associated with various dolly characteristics such as listed above. Other information may include road grade information, map information or any real-time information and the like.

All, or parts of this, information is then transmitted to, and received by, the intelligent controller 502 within the dolly (step 1000). In terms of the signals received from the vehicle OBD, in some embodiments, the digital signals from the vehicle OBD 524 are converted by the power line communication unit 522 and then transmitted over the truck electric line 526. These signals are then retrieved, or received, by the power line communicator unit 504 within the dolly and then extracted, and, if necessary, re-converted before being received by the controller 502. As will be understood, the power line communicator unit 504 converts the extracted signals into a format understandable by the controller 504. As will be understood, due to the connection between the dolly and the trailers (via the connectors 518 and 520), the dolly control system 502 has access to any signals and electricity that is transmitted over the electric line 526.

In some embodiments, the digital signals may be transmitted wirelessly from the vehicle OBD 524 to the controller 502 via the communication interface 68.

After the controller 502 receives the digital signals, the controller processes the signals (step 1002) and then generates dolly control signals to control the dolly (step 1004) based on the digital signals. The dolly control signals may also be seen as motor-generator drive control signals.

For instance, if the towing vehicle 13 is braking, the controller 501 may receive digital signals representing the level of braking being applied to the truck. In one embodiment, this is determined by the vehicle OBD by monitoring the position of the brake pedal within the truck. After receiving the digital signals, either directly from the vehicle OBD or converted by the power line communicator unit, the controller can generate and send a signal to the motor-generators 36 (via the motor-generator drive 508) to apply a corresponding regenerative brake motive rotational force. In this manner, during this regenerative braking, the battery can be charged based on the braking motive rotational force value calculated by the controller.

In another embodiment, the controller 502 may receive a digital signal indicating that the truck is being started. If the battery is charged or has some charge, the controller may generate and transmit a signal to the motor-generator to apply or generate a motive rotational force to assist start-up of the truck to improve the efficiency of the truck motor.

In another embodiment, if the state of charge (SOC) within the dolly's battery is low, signals relating to the truck engine's maximum efficiency may be received by the controller whereby the controller may then generate and transmit a signal to the kinetic energy recovery device to charge the battery when possible.

Turning to FIG. 5c, a flowchart outlining a method of communication from the dolly control system is shown. Initially, dolly information signals, which are typically digital, may be converted (step 1010) if they are being transmitted to a truck driver over the electric line as discussed above. The dolly information may include information relating to the dolly's position, the battery charge, or the like.

The dolly information signals are then transmitted (step 1012) to specified destinations or individuals, such as, but not limited to, the truck driver or a fleet manager. As will be understood, the signals may be transmitted wirelessly via the communication interface 68 or via the electric line 526 to the truck driver. The step of signals being transmitted to the fleet manager is generally performed wirelessly.

The active converter apparatus 14, as outlined above, may be considered in some embodiments a TTR hybrid system. As such, the dolly apparatus 14 in some embodiments operates in different operational modes.

In one mode, the active converter dolly 14 does not participate in extracting or providing power to the tractor-trailer system. In this mode, the converter dolly will be passive. In another mode, sometimes referred to as an anti-idling mode, auxiliary loads (for example cabin's or trailer's A/C system) are driven by the kinetic energy recovery device 30 of the dolly 14 or the stored energy in its energy storing device 32. In yet another set of modes, such as a drive mode and a stability-assistance mode, the energy in the dolly's energy storing device 32 is used to provide traction motive rotational force in the dolly's tires 22 to assist the motion of the tractor-trailer vehicle 10. In another mode, referred to as generator mode, the dolly is used to extract and convert the mechanical power in the rotation of its wheels into electric power via its motor-generators using regenerative braking. The electric power then can be stored in the energy storing device 32 and/or run auxiliary devices of the tractor-trailer vehicle 10. This mode may activated during regenerative braking or when the truck-trailer drives downhill, or when the energy storing device 32 needs to be charged, in which it may be activated when the engine is operating at high efficiency.

In a further mode, called electric-vehicle (EV) mode, the dolly apparatus 14 may use the power stored in the energy storing device 32 to power the motor-generators 36 to push the entire tractor-trailer vehicle 10 forward when it is moving at low speeds. In another mode, called backup-assistance mode, the motor-generators are employed to stabilize and straighten the tractor-trailer vehicle 10 when backing up.

Some of these modes are described in more detail below.

In further designing one embodiment of the dolly, certain driving conditions are considered. These conditions may include, but are not limited to, acceleration (when the vehicle's velocity is increasing); deceleration (when the driver releases the accelerator pedal and may press the brake pedal); and cruising (when the road load and the vehicle's velocity are constant).

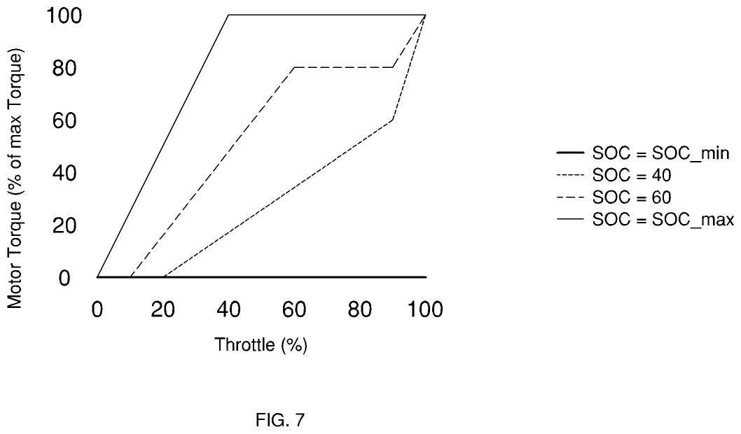

An example of drive mode is as follows. During acceleration, if there is enough charge in batteries, and when the state of charge (SOC) of the battery is greater than the SOC threshold acceleration, the dolly may assist the truck's powertrain via the electric motor associated with the dolly wheels, providing an additional boost motive rotational force in addition to the motive rotational force generated by the tractor. In one embodiment, the SOC threshold acceleration can be a predetermined threshold calculated via experiments or system optimization calculations. This boost motive rotational force depends on vehicle speed, the battery's SOC, and the accelerator pedal position. A sample map for electric motor output during acceleration at a sample vehicle speed equal to 50 km/h for various battery SOCs is shown in FIG. 7.

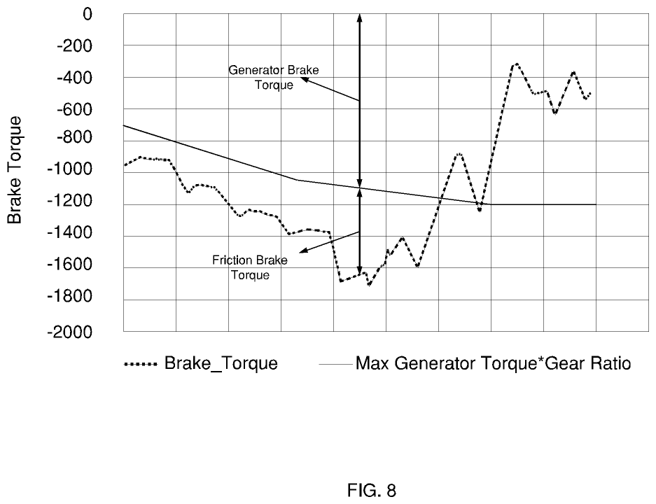

An example of generator mode is as follows. During deceleration, if the battery is or batteries are not fully charged, the dolly 14 typically does not assist the truck or other towing vehicle 13 nor add any load to the truck to extract any energy. During coasting and based on the battery's SOC, the dolly 14 may extract power via the motor-generator 36 for charging the batteries 32. However, when the brake pedal is depressed, parallel regenerative braking is actuated. Depending on vehicle speed and consequently, the generator's rotational speed, for approximately 10-20% of initial brake pedal travel, the friction brakes are not engaged and only regenerative braking is applied. During harder braking conditions, depending on the value of generator speed and max motive rotational force, the braking energy may not completely regenerated. In these situations, the excessive amount of braking motive rotational force is applied by friction braking, as shown in FIG. 8. This process is called brake motive rotational force blending.

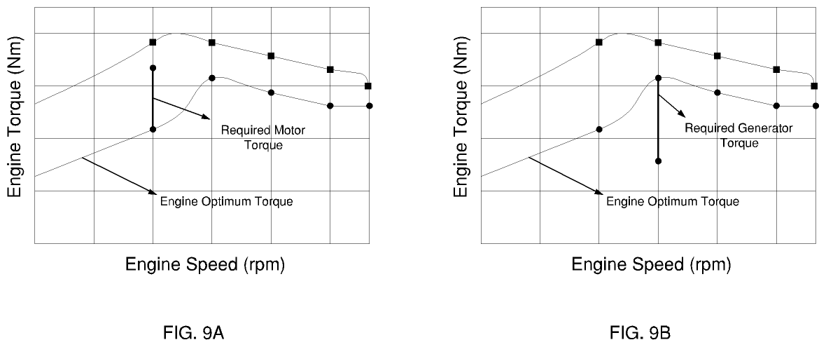

An example of alternating drive mode and generator mode is as follows. During cruising, depending on the status of load, or drive motive rotational force, relative to optimum load, or drive motive rotational force, the dolly 14 may assist the truck powertrain, being in drive mode, or extracting power via the generator in generator mode. In this situation, if the truck powertrain motive rotational force is greater than the optimum motive rotational force of the engine at that speed, the dolly will be in assist mode (i.e. drive mode), in which the electric motor of the motor-generator 36 provides a boost motive rotational force in addition to the truck motive rotational force output, as shown in FIG. 9a. Consequently, there is a lower motive rotational force request from the engine due to the available motor motive rotational force, which results in a more-efficient tractor operating point. Finally, if the engine toque is less than the optimum load, or drive motive rotational force, the dolly 14, depending on the SOC of the battery 32, will be in generator mode: the truck powertrain delivers its power to the load and the load delivers power to electric powertrain, as shown in FIG. 9b. In this situation, some portion of engine power is stored in the batteries 32 by the motor-generator 36, and the extra requested motive rotational force from the drive of the towing vehicle (such as an internal combustion engine, ICE) moves the current towing vehicle drive operating point to a more efficient one.

With respect to some embodiments of the active converter dolly, certain characteristics of the dolly are required. More specifically, power and performance, powertrain configuration, and steerability are taken into account in the design of some embodiments of the active converter dolly 14.

With respect to the powertrain configuration, two scenarios, seen as an in-wheel motor embodiment and a drive axle embodiment can be considered.

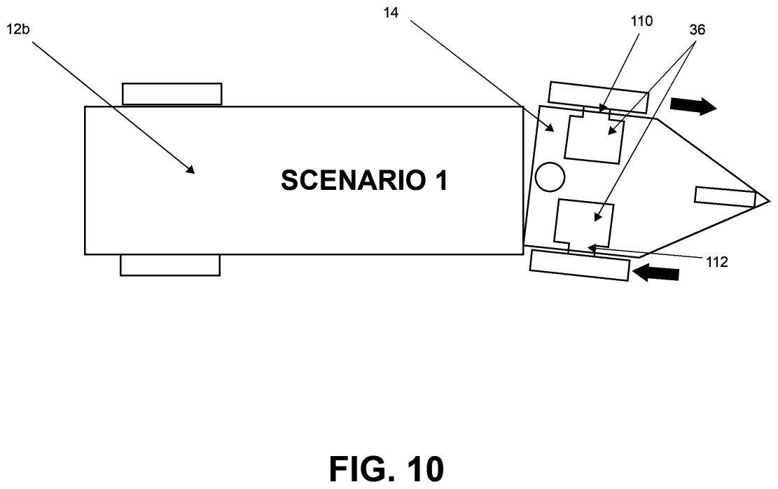

For embodiments with an in-wheel motor configuration, the kinetic energy recovery device 30 includes two drive shafts 110, 111 with two in-wheel motor-generators 36, such as schematically shown in FIG. 10. As shown in FIG. 10, the apparatus 14 is connected to the second trailer 12b. The motor-generators 36 can provide the required power for driving, and by applying different traction forces, it can play the role of a steering system. While this configuration may require a higher level of modification to be retro-fitted into existing converter dollies, it may more suitable for Vehicle Dynamic Control (VDC) applications because the left and right motors can be operated independently to provide different traction/braking motive rotational force to each wheel. By controlling this properly, a corrective yaw moment is formed, which can be used to improve dynamical behaviour of the combination of the towing vehicle, trailers, and the converter dolly.

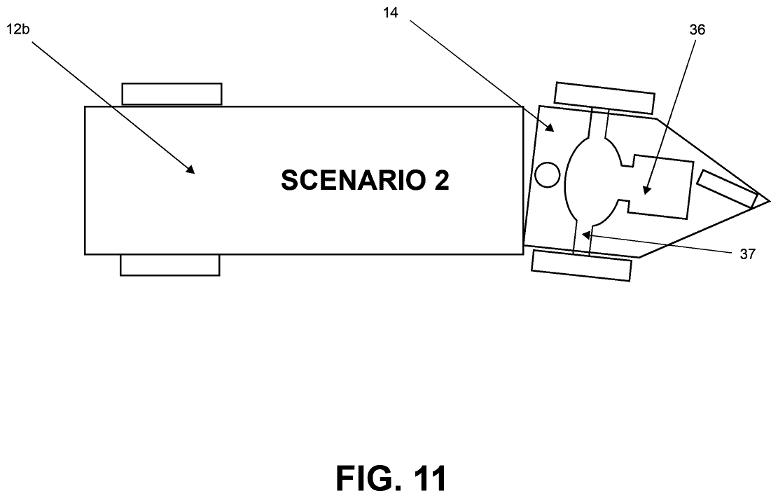

For the drive-axle embodiment, in this configuration, the axle 37 is a drive axle such as schematically shown in FIG. 11. Unlike the system of FIG. 10, the level of modification for this configuration is lower. Furthermore, in some embodiments, the motor-generator includes a motor-generator reduction gear, which can also be embedded into the axle, 37 (double reduction axle).

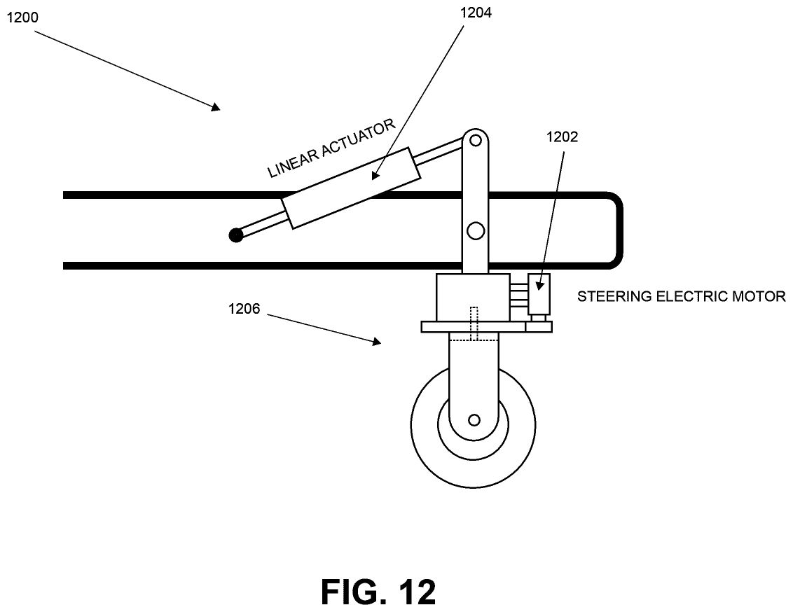

When the active converter dolly or apparatus 14 is disconnected from a first trailer 12a but still connected to a second trailer 12b, the apparatus 14 can be used to move the second trailer 12b without having to go through the hassle of re-mounting the first trailer 12a. With respect to steerability, in the in-wheel motor configuration shown in FIG. 10, the steering may be altered by differential motive rotational force applied by each motor-generator 36. In the drive-axle configuration shown in FIG. 11, a steering mechanism 1200 may be integrated with the converter dolly 14. A schematic of the steering mechanism 1200 that can be used for an active converter dolly 14 is shown in FIG. 12. The steering can be achieved by using a motor 1202. Either an electric or a hydraulic linear actuator 1204 can also provide the retractability of the steering mechanism, which can also be seen as a third wheel assembly or coaster wheel 1206. However, since using a hydraulic actuator may require additional power sources and accessories (hydraulic power and connections), some embodiments may use an electric linear actuator. In some embodiments, for example, a steering device for releasably coupling to the steering mechanism is provided for assisting with steering of the apparatus 14 and second trailer 12b when the apparatus 14 and second trailer 12b are disconnected from the first trailer 12a. In some embodiments, for example, the steering device includes a steering column and steering wheel.

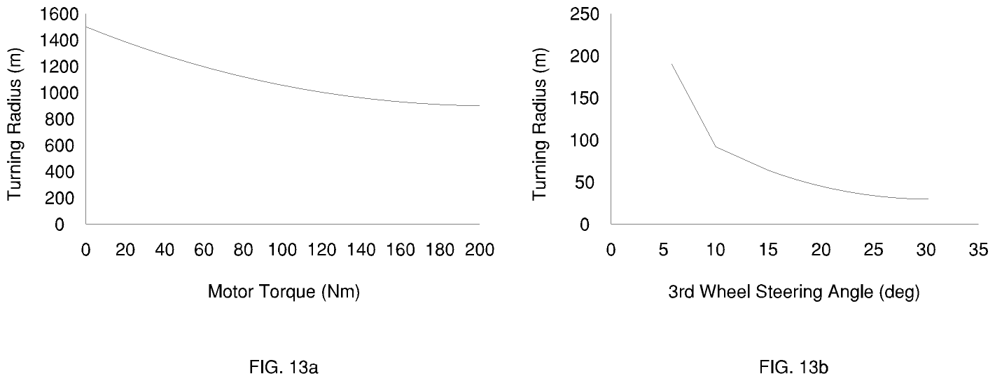

Using the related equation of motion for the articulated vehicles, the steerability of both configurations (of FIGS. 10 and 11) were investigated. FIGS. 13a and 13b illustrate the turning radius of the trailer equipped with an active converter dolly with differential motive rotational force steering (FIG. 13a) and steering mechanism (FIG. 13b) configurations.

It can now be appreciated that the active converter dolly or apparatus 14 may not only improve fuel economy when it is attached to the tractor-trailer but can also be used to shunt a trailer when it is not attached to a trailer with adding a steering mechanism. Although not shown, a steering wheel, joystick, or other interfaces can also be included to communicate with the dolly controller to enable a driver locally or remotely to steer the dolly. As such, the dolly can be used to shunt the second trailer around a staging area even when the second trailer is disconnected from the tractor. This may be to place the second trailer in position for loading or unloading, or to place it in position for being attached to a trailer. Because the apparatus 14 is equipped with a steering system and by the dolly control system, the apparatus 14 can be directed or steered into position. In some embodiments, the steering can be manually applied, such as by way of a remote control device. Such a device may be a joystick, smart phone or tablet device, which includes software access to the steering control or mechanism. In this way, the apparatus 14 can be controlled remotely while it is being maneuvered into position. Collision avoidance sensors may also be used to help avoid accidents. The collision avoidance sensors may be ultrasonic sensors, LI DAR, RADAR, or other suitable proximity detector sensor. The collision avoidance sensors may be mounted on the second trailer 12b or may be mounted on the apparatus 14 in a way that permits the dolly sensors to see past the edges of the second trailer 12b for collision avoidance.

In some examples, a steering device may be coupled to the steering mechanism. The steering device may be communicatively coupled to the controller for locally or remotely steering the apparatus 14 by an operator (e.g. driver), the apparatus 14 being operable by the steering device to shunt the second trailer 12b around a staging area, for example, while the second trailer 12b is releasably coupled to the apparatus 14 and disconnected from the towing vehicle 13 (for example, while the first trailer 12a, which is releasably couplable to the towing vehicle 13, is decoupled from the apparatus 14). The steering device may comprise a steering wheel or joystick mounted to the apparatus 14. The steering device may be a wireless communication device for wireless communicating with the controller, such as a wireless remote control having a steering wheel or joystick, smartphone or tablet, the wireless communication device having control software for providing a user interface for steering the apparatus via user interaction therewith.

The collision avoidance sensors may be communicatively coupled to the controller. The collision avoidance sensors may be mounted to the apparatus or the second trailer to detect any objects within a threshold distance of the apparatus or the second trailer, and the controller configured to generate an alert when an object is detected within the threshold distance of the apparatus or the second trailer. Alternatively, the controller may be configured to send a notification of the steering device when an object is detected within the threshold distance of the apparatus or the second trailer, with the steering device configured to generate an alert when an object is detected within the threshold distance of the apparatus or the second trailer. The alert may be one or more of an audible alert, visual alert, or physical alert such as a vibration.

The above remote control and collision avoidance sensor features have been described in reference to a human-operated steering control system. However, in some embodiments, the steering of the apparatus may be accomplished by an algorithm enabling autonomous movement. In one example, the algorithm may be an autonomous vehicle operation algorithm resident on the apparatus itself and running on the controller. In another example, the algorithm may be resident on a remote controller, such as a server in communication with the apparatus via a wireless communication interface. Such an algorithm may make use of sensors fitted to the apparatus itself, such as the various sensors described above, possibly in combination with other sensors commonly used in autonomous vehicle applications, such as camera arrays and LIDAR sensors. The algorithm may also make use of sensors installed in the environment being navigated; e.g., in an example apparatus designed to navigate within a controlled environment such as a drop yard for trailers, the drop yard may be equipped with cameras, proximity sensors, LIDAR arrays or other sensors to enable the algorithm to operate vehicles within the yard autonomously, and to coordinate the operation of multiple such vehicles. Deployment of such an apparatus within a controlled environment such as a drop yard would potentially make the problem of safe and effective autonomous operation of such a vehicle easier to solve.

Other embodiments may implement the remote-control and/or collision avoidance sensor features described above using a different vehicle platform from the converter dolly embodiments described above as part of an application to enable a trailer to be shifted or relocated within a drop yard or other location. Several such alternative vehicle platforms shall now be described.

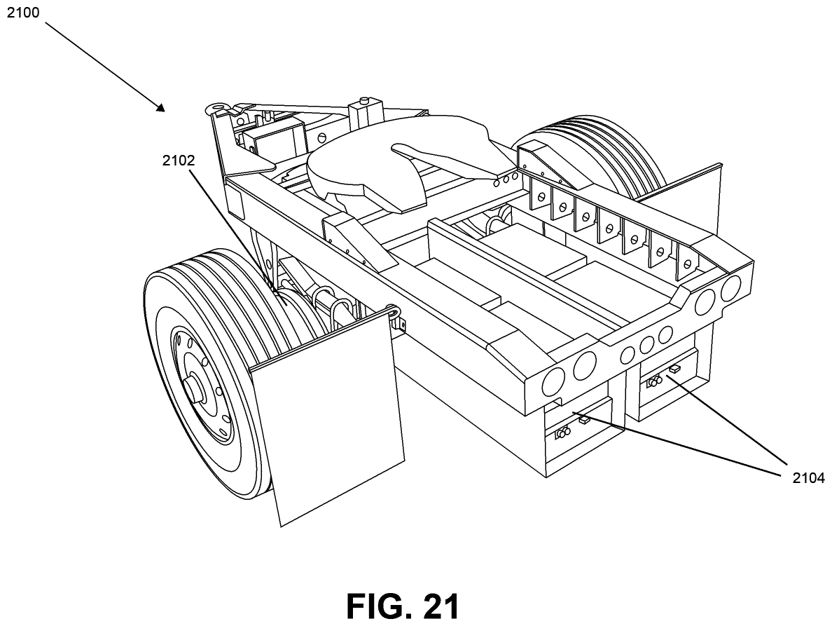

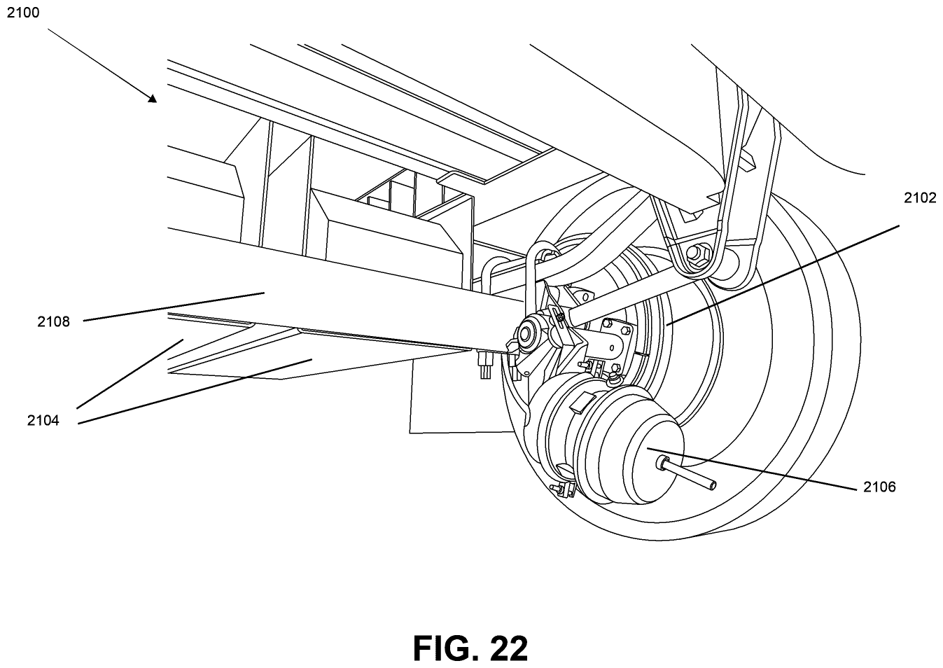

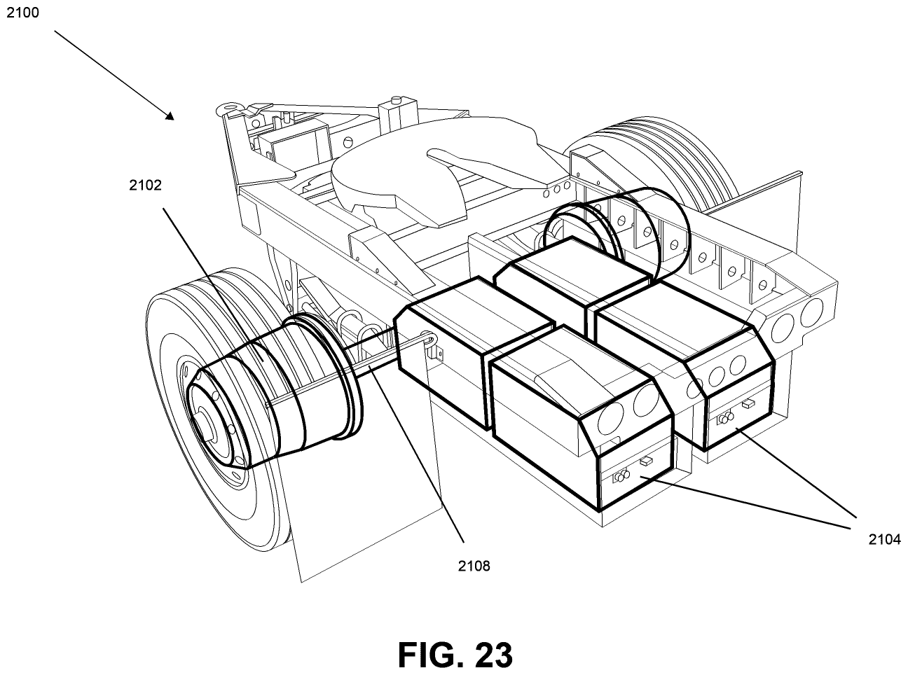

With reference to FIG. 21, an alternative one-axle converter dolly 2100 is shown. The dolly 2100 makes use of in-hub motor-generators 2102 situated within the hub of each wheel. It also has an array of batteries 2104 situated in easily-accessible cabinets at the rear of the dolly 2100 for easy replacement. FIG. 22 shows a detailed close-up view of the undercarriage of the dolly 2100, with an in-hub motor-generator 2102 and the batteries 2104 visible. A passive fixed axle 2108 is affixed to the frame of the dolly 2100 and is used to support the motor-generators 2102 and wheels. FIG. 23 shows a cutaway version of FIG. 21 with the placement of the in-hub motor-generators 2102 inside the wheel hubs more clearly visible, with the placement of the batteries 2104 more visible, and with the fixed axle 2018 more visible. The features described above with respect to the converter dolly may be implemented using this alternative dolly 2100 as a platform. For example, the dolly 2100 may be steerable using in-hub motor-generators as shown in FIG. 21, using differential steering mechanism by applying different torque to the right and left wheels.

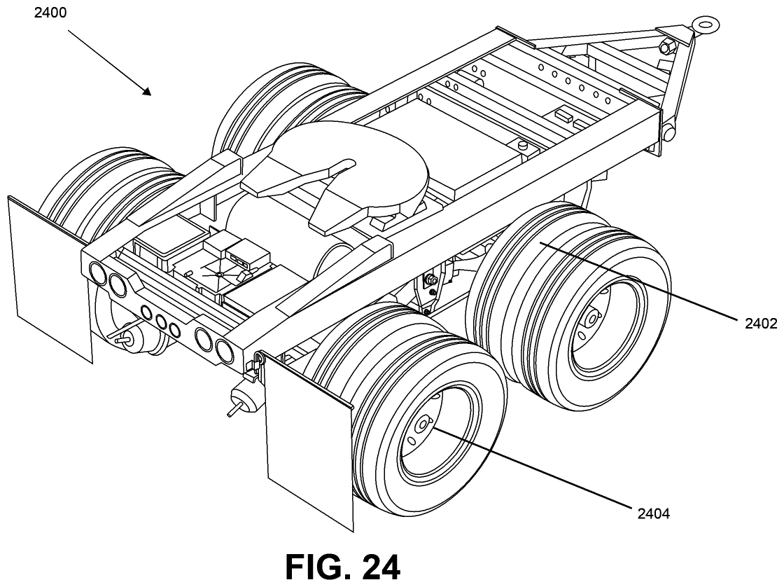

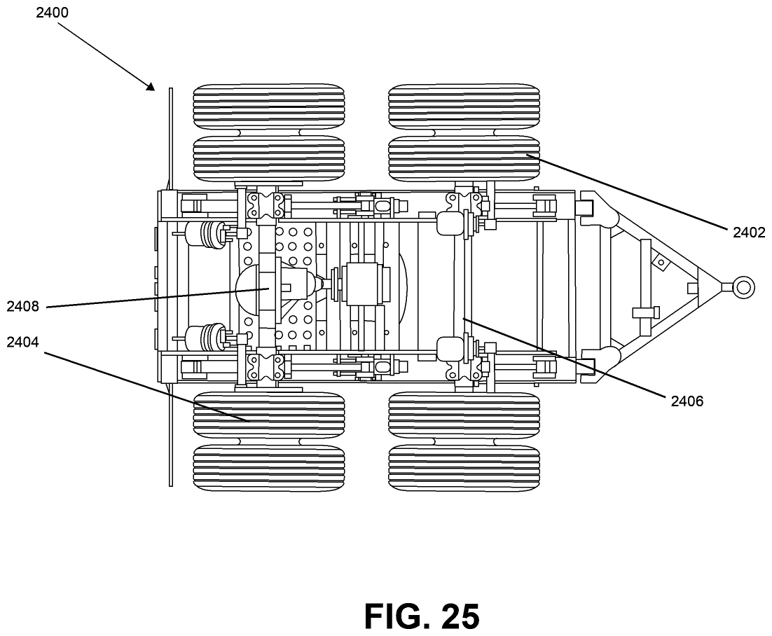

With reference to FIG. 24, an example two-axle dolly 2400 is shown with a second pair of wheels 2402 in addition to the first pair of wheels 2104. In different embodiments, either the first pair 2404 or the second pair 2402 of wheels, or both, may be coupled to motor-generators. In some embodiments, this two-axle dolly 2400 may exhibit more stability than the one-axle embodiments previously described when decoupled from the lead vehicle. This may, in some embodiments, dispense with the need for a trailer jack 627 or third wheel assembly 1206 when steering the dolly 2400 when it is decoupled from a lead vehicle. FIG. 25 shows a bottom view of the two-axle dolly 2400 with a motor-generator 2408 driving the rear first pair of wheels 2404 and the second pair of front wheels 2402 turning passively on a passive axis 2406. The features described above with respect to the converter dolly may be implemented using this alternative two-axle dolly 2400 as a platform. For example, the dolly 2400 may be steerable using either an Ackerman steering axle (as in a conventional automobile) or, if it has in-hub motor-generators, it may use a differential steering mechanism by applying different torque to the right and left wheels.

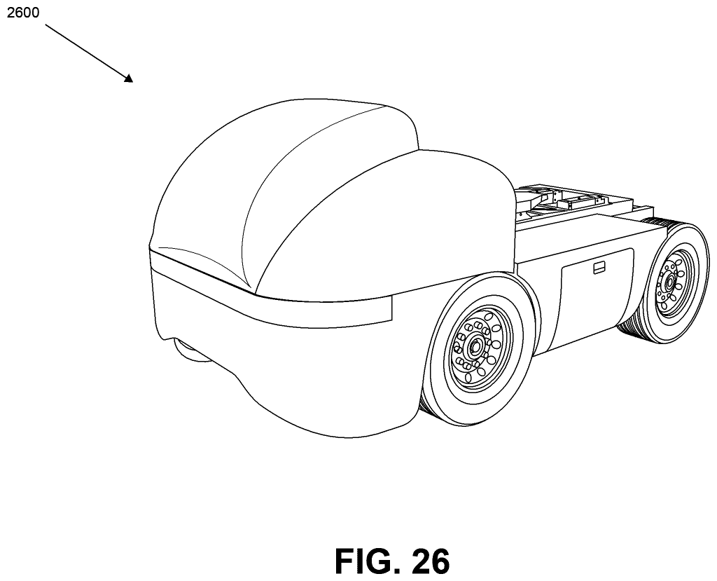

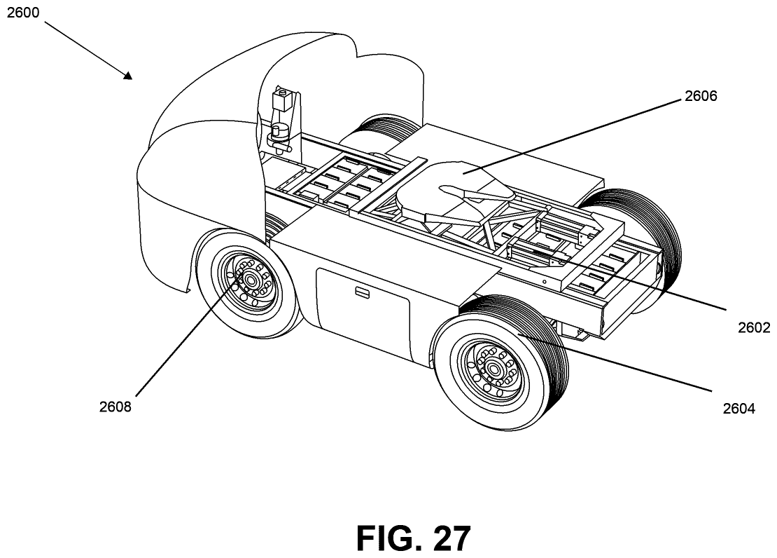

With reference to FIG. 26, an example terminal tractor 2600 is shown. An additional view is provided in FIG. 27. The tractor 2600 has a front pair of wheels 2608 and a rear pair of wheels 2604, at least one of which is driven by an electric motor powered by a battery array 2602. It has a fifth wheel assembly 2606 for coupling to a trailer. In various embodiments, the tractor 2600 may implement any combination of the features of the converter dolly described herein. In particular, it contains a controller and a wireless communication interface enabling remote control steering of the tractor 2600 to tow trailers within an environment such as a drop yard, in accordance with the remote control steering features described above.

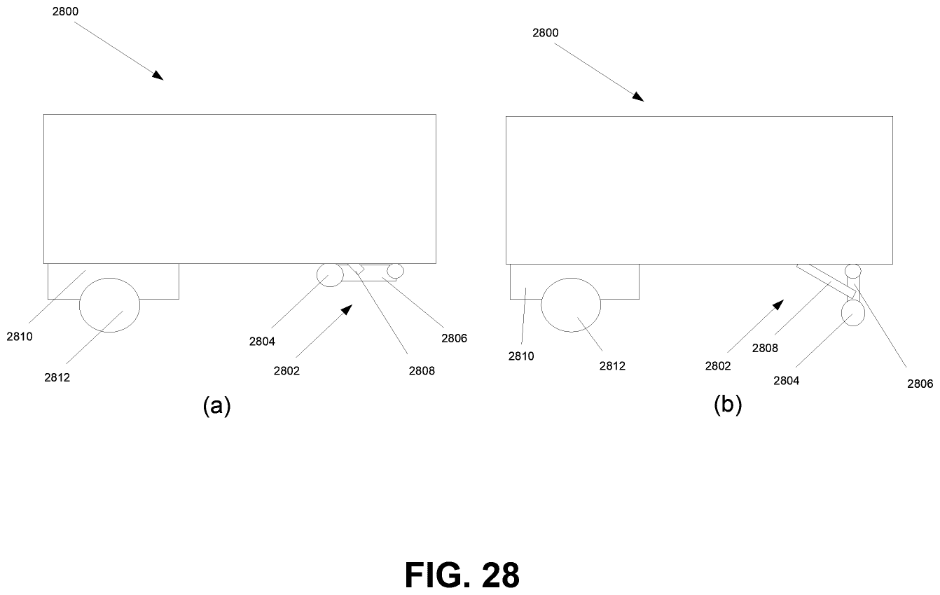

With reference to FIG. 28, a further alternative vehicle form is illustrated as an example platform for the remote control steering feature and other features described herein. A powered trailer 2800 is shown in FIG. 28(a) with a retractable front wheel 2802 in a retracted position, and in FIG. 28(b) with the retractable front wheel 2802 in an extended position. The front wheel 2802 may in some embodiments be implemented identically to the third wheel assembly 1206 of a converter dolly as described above with reference to FIG. 12. In other embodiments, the front wheel 2802 may not be steerable, and the trailer may depend on differential drive applied to the two back wheels 2812 by one or more motors or motor-generators 2810 to steer the trailer 2800. In some embodiments, there may be two front wheels 2802, one on either side.

The retractable front wheel 2802 in this embodiment consists of a swingable support 2806 rotatably mounted to the bottom of the trailer 2800. An actuator 2808, such as a piston, hydraulic cylinder or solenoid, is used to extend or retract the support 2806. At the distal end of the support 2806 is a wheel 2804.

The trailer 2800 in some embodiments may be a conventional trailer retrofitted with an electric or hybrid drive system (e.g. electric motor-generator 2810), including a controller, battery array, and the other features described above with respect to a converter dolly apparatus, as well as the retractable wheel 2802. In other embodiments, the trailer may be custom-built to incorporate these features. In some embodiments, it is not a full trailer but a container chassis for carrying shipping containers. In various embodiments, the trailer 2800 may implement any combination of the features of the converter dolly described herein, including the remote control steering feature, which would enable the trailer 2800 to move itself within a drop yard or other environment.

The remote control feature described above presents potential advantages to a driver dropping off a trailer at a drop yard. Ordinarily, a driver of a road train must exit the cab of the towing vehicle to disconnect the secondary trailer, re-enter the cab of the towing vehicle (with the primary trailer and the converter dolly still attached), then drive forward to decouple the secondary trailer. The driver then leaves the cab a second time to disconnect the dolly from the primary trailer, and then moves the dolly to a dolly parking area. The driver then re-enters the cab to drive the primary trailer to its desired location, de-couples the primary trailer from the towing vehicle, and subsequently returns with the towing vehicle to move the secondary trailer to its desired location. Alternately, a driver-operated terminal tractor will come to move the secondary trailer to its location while the primary trailer is been moved. With the remote-control feature described above, the driver simply exits the towing vehicle to disconnect the electric dolly from the primary trailer, and then leaves in the towing vehicle to park the primary trailer. The secondary trailer will be moved by the electric converter dolly to its desired location, where the electric converter dolly is controlled remotely, either manually or autonomously. This reduces the required number of times that the driver needs to exit the tractor from three times down to one.

Similarly, the use of the alternative vehicle platforms described above can reduce the number of operations for a driver dropping off one, two, or more trailers. A self-driven trailer 2800 can be decoupled and then remotely controlled to its desired location. Similarly, a remotely controlled terminal tractor 2600 can be used to relocate one or more trailers and/or converter dollies once they are decoupled from the towing vehicle and/or the rest of the road train.

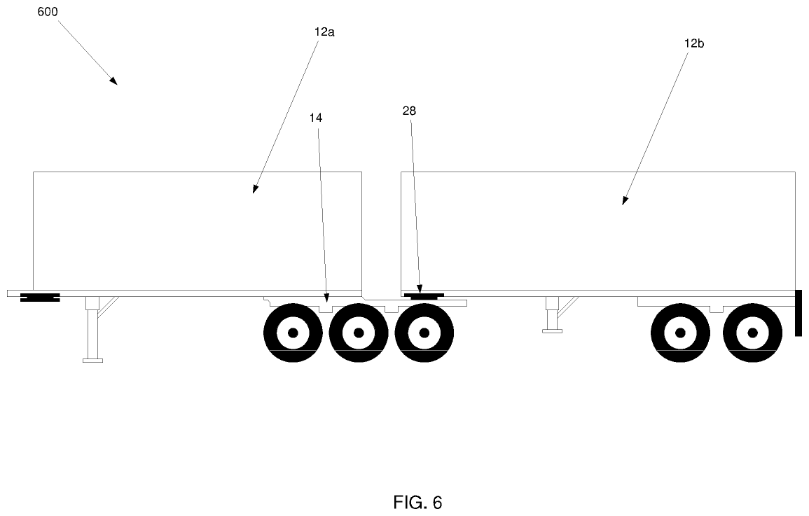

Turning to FIG. 6, another schematic embodiment of an active converter dolly 14 in a B train configuration 600 is shown, in which the active converter 14 is part of the first trailer 12a. In this configuration, the fifth wheel assembly 28 sits on the rear axle of the first trailer 12a. Similar to the embodiment discussed previously and shown in FIG. 1, which may be referred to as an A train configuration, the active converter dolly 14 in a B train configuration 600 is capable of adding power to drive the trailers and to being able to capture energy from regenerative braking. In B train active dollies, at least one of the axles may be electrified as discussed above for adding power to drive the trailers and to being able to capture energy from regenerative braking. Similarly, in A train active dollies with multiple axles, at least one of the axles may be electrified. Electrifying more axles may improve the fuel efficiency and performance of the active converter dolly apparatus 14.

Turning to FIG. 14, a perspective view of a second example embodiment of an active convertor dolly is shown.

In this embodiment, the active converter dolly apparatus 614 includes the same overall structure as the apparatus 14 of FIG. 2a: a frame 24 including a wheel supporting portion 9 and tongue portion 8; a first trailer connection assembly 7, illustrated here as a hitch 26; two sets of wheels 22 mounted to the wheel supporting portion 9; and a second trailer mounting assembly 6 in the form of a fifth wheel assembly 28 mounted to the top of the frame 24.

However, several of the components are have been relocated or altered in this embodiment relative to the embodiment of FIG. 2a. The energy-storing device 32 of FIG. 2a is replaced here with a battery array 632, and the enclosure 34 is not shown in this illustration. The support leg or apparatus 27 of FIG. 2a is shown here in the form of a detachable trailer jack 627. The trailer jack 627 can be used to raise or lower the height of the tongue portion 8 of the apparatus 14 using the included hand-operated crank 650. This embodiment of the apparatus 14 also includes a trailer jack drive 652 coupled to the kinetic energy recovery device 30. The trailer jack drive 652 is powered by the battery array 632, operable to raise or lower the trailer jack 627 as an alternative to the crank 650.

The various components of the kinetic energy recovery device 30 are also relocated in this embodiment from the wheel supporting portion 9 to the tongue portion 8. By locating the battery array 632 and kinetic energy recovery device 30 to the tongue portion, or to an area intermediate the first trailer connector assembly 8 and the second trailer connector assembly 6, this embodiment locates these components farther from the underbody of the second trailer, thereby potentially facilitating cooling and reducing mechanical interference from the second trailer 12b. By locating the battery array 632 and sensitive components of the kinetic energy recovery device 30 to a location intermediate the first trailer connector assembly 8 and the second trailer connector assembly 6, the likelihood of mechanical interference from the first trailer 12a is also reduced. In some embodiments, for example, the tongue portion 8 defines an opening wherein the battery array 632 and other components of the kinetic energy recovery device 30 are disposed within the opening and secured to the frame 24.

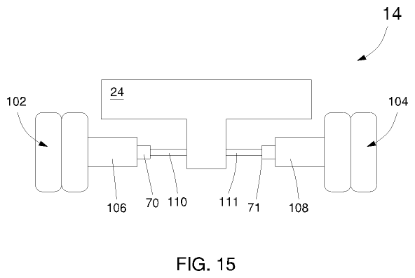

FIG. 15 is a rear view of an example dolly apparatus 14 with an in-wheel motor configuration, showing details of the axle and wheel configuration. The apparatus 14 has a first wheel 102 on a first side of the frame 24, driven by a first motor-generator 106 and connected to a first drive shaft 110. A first wheel speed sensor 70 is located at the first wheel assembly. The first wheel speed sensor 70 may be attached to the first wheel 102 or the first drive shaft 110 for collecting wheel speed data and providing it to the controller 502. The apparatus 14 also has a second wheel 104 on a second side of the frame 24, driven by a second motor-generator 108 and connected to a second drive shaft 111. A second wheel speed sensor 71 is located at the second wheel assembly. The second wheel speed sensor 71 may be attached to the second wheel 104 or the second drive shaft 111 for collecting wheel speed data and providing it to the controller 502.

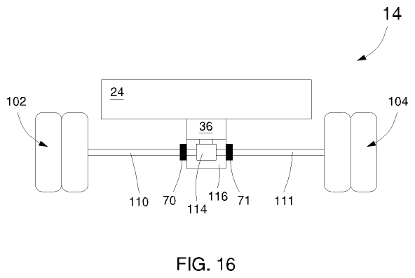

FIG. 16 is a rear view of an example active converter dolly apparatus 14 with a two axle-differential configuration, showing details of the axle and wheel configuration. The converter dolly 14 includes a two-part central axle split into a first drive shaft 110 and a second drive shaft 111, one electric motor-generator 36, and a differential 116. The first drive shaft 110 and second drive shaft 111 may in some embodiments be releasably locked together by an axle locking device 114 in response to a wheel-locking control signal from the controller 502. When locked together, the first drive shaft 110 and second drive shaft 111 rotate as a single axle.

In the differential configuration of FIG. 16, there may be less space to house the enclosure 34 between the wheel sets, however, the other aspects remain the same. The enclosure 34 may require an adaptation to permit the drive shafts 110,111 to traverse the compartment, and the motor-generator 36 also needs to be connected through the differential 116. However, even with a central transverse axle, this embodiment may include the aerodynamically efficient, lightweight, waterproof and corrosion resistant battery enclosure 34 and an instrumentation package of appropriate modules to allow for interfacing with the towing vehicle motor control system, to interface with the proximity sensors to provide a back-up steering system, to interface with a remote controller to permit the dolly to be remotely steered around even when disconnected for the tractor trailer train and will allow the dolly to operate equally well in forward or reverse.

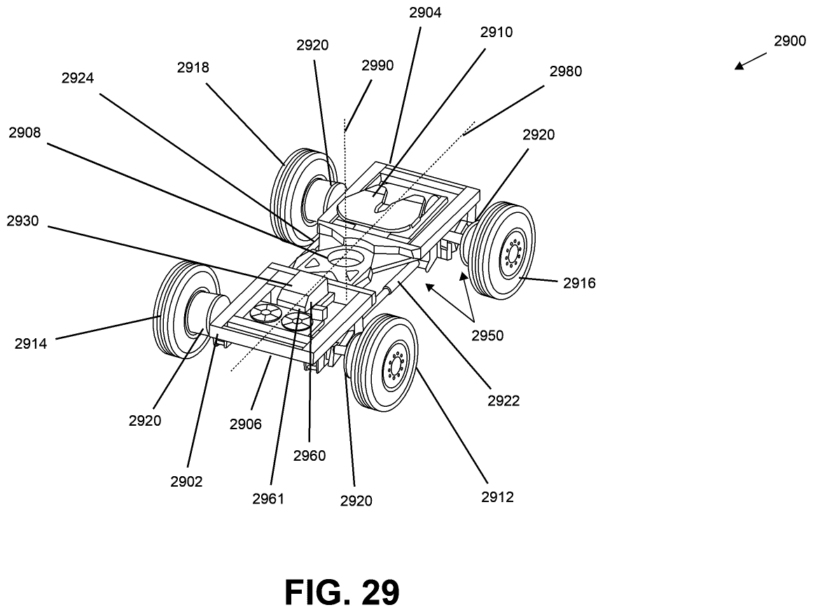

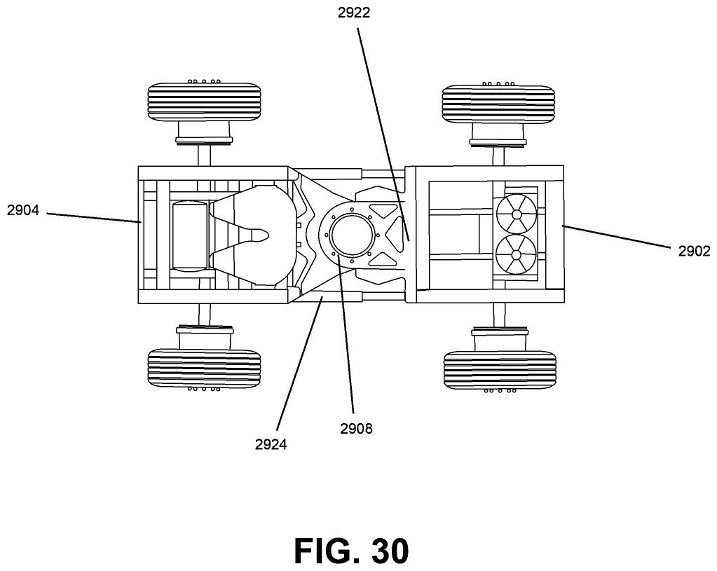

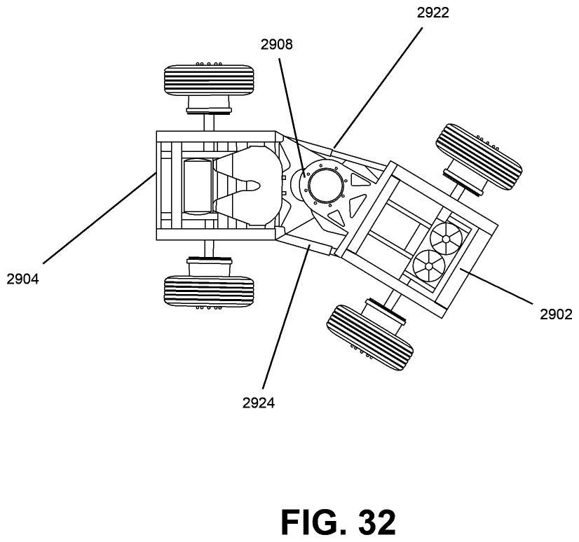

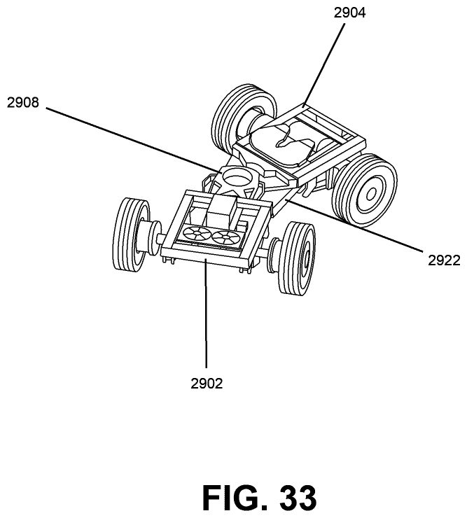

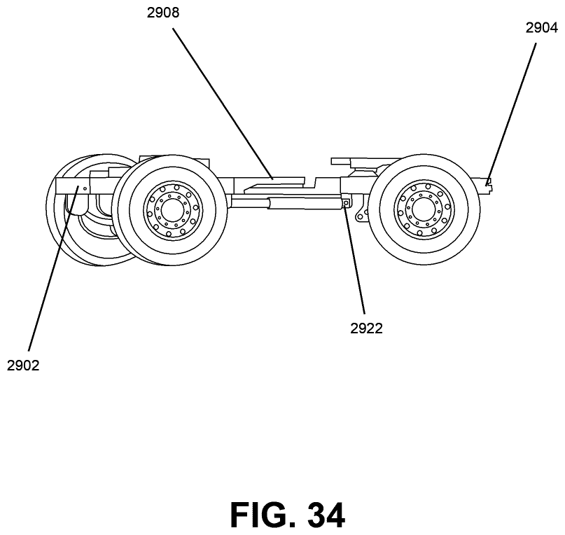

FIGS. 29 to 34 depict an alternate embodiment of an apparatus 2900 for towing trailers. The apparatus 2900 substantially corresponds to the dollies, terminal tractors, and yard shifters as described herein, except the frame 2906 of the apparatus 2900 is an articulated frame. In some embodiments, for example, the frame 2906 is defined by a first frame counterpart 2902 and a second frame counterpart 2904 that are pivotably connected.

In some embodiments, for example, as depicted in FIGS. 29 to 34, the apparatus 2900 includes two frame counterparts that pivot in the yaw angle with respect to each other, thereby creating a turning motion. In some embodiments, for example, the apparatus 2900 does not require a steering axle. In some embodiments, for example, the articulating motion is created based on: (i) the difference in wheel torque per axle, (ii) using linear actuators between the two frame counterparts to create the pivot motion, or (iii) a combination of both. In some embodiments, for example, to generate torque difference between the two wheels per axle, in-hub motors are utilized, where individual wheel speed and torque can be independently controlled. In some embodiments, for example, while there is a difference in the speed and torque between the wheels on the axle, the torque difference will pivot the frames and create a turning motion of the apparatus 2900. In some embodiments, for example, one or more linear actuators are placed between the two frame counterparts and by extending or retracting the length of the one or more linear actuators, pivoting between the frame counterparts can be urged.

A pivotable connection 2908 connects the first frame counterpart 2902 and the second frame counterpart 2904 together and permits for a pivoting motion at the pivotable connection 2908. In some embodiments, for example, the pivotable connection 2908 is configured to support large vertical loads, for example, the weight of one or more trailers. In some embodiments, for example, the apparatus 2900 with an articulated frame may eliminate the need for a steering axle and a system, for example, a hydraulic system, to drive the steering axle, such that the number of subsystems of the apparatus 2900 is reduced and the packaging and the design of the apparatus 2900 may be simplified.

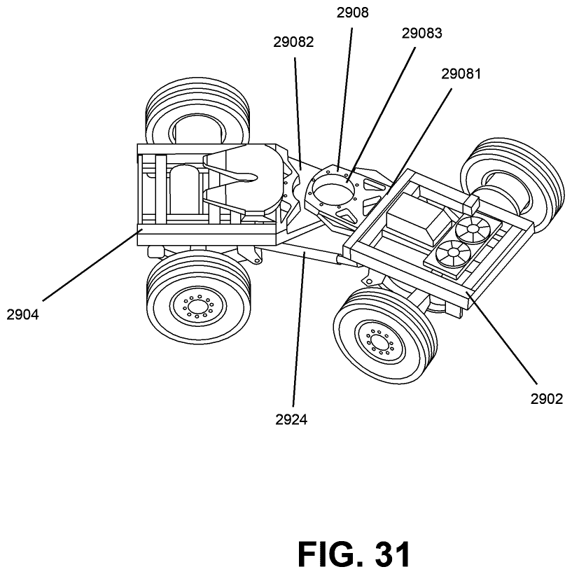

In some embodiments, for example, as depicted in FIG. 31, the pivotable connection 2908 includes a first pivotable connection counterpart 29081 and a second pivotable connection counterpart 29082 that pivot relative to each other. In some embodiments, for example, the first pivotable connection counterpart 29081 is connected to the first frame counterpart 2902 via mechanical fasteners, such as screws, nuts and bolts, welding, and the like. In some embodiments, for example, the first pivotable connection counterpart 29081 and the first frame counterpart 2902 are of unitary one piece construction. In some embodiments, for example, the second pivotable connection counterpart 29082 is connected to the second frame counterpart 2904 via mechanical fasteners, such as screws, nuts and bolts, welding, and the like. In some embodiments, for example, the second pivotable connection counterpart 29082 and the second frame counterpart 2904 are of unitary one piece construction.

In some embodiments, for example, as depicted in FIG. 31, the pivotable connection 2908 includes a bearing 29083 to effect the relative displacement, for example, the relative pivoting, of the first pivotable connection counterpart 29081 and the second pivotable connection counterpart 29082. In some embodiments, for example, while the first pivotable connection counterpart 29081 and the first frame counterpart 2902 are connected, and while the second pivotable connection counterpart 29082 and the second frame counterpart 2904 are connected, the first pivotable connection counterpart 29081, the second pivotable connection counterpart 29082, and the bearing 29083 are co-operatively configured to effect the relative displacement, for example, the relative pivoting, of the first frame counterpart 2902 and the second frame counterpart 2904. In some embodiments, for example, the pivotable connection 2908 includes a ball joint to effect the relative displacement, for example, the relative pivoting, of the first connector counterpart 29081 and the second connector counterpart 29082. In some embodiments, for example, while the first pivotable connection counterpart 29081 and the first frame counterpart 2902 are connected, and while the second pivotable connection counterpart 29082 and the second frame counterpart 2904 are connected, the first pivotable connection counterpart 29081, the second pivotable connection counterpart 29082, and the ball joint are co-operatively configured to effect the relative displacement, for example, the relative pivoting, of the first frame counterpart 2902 and the second frame counterpart 2904.

As depicted in FIGS. 29 to 34, the apparatus 2900 for towing trailers 12 comprises the first frame counterpart 2902 and the second frame counterpart 2904, wherein the first frame counterpart 2902 is connected to the second frame counterpart 2904 such that a frame 2906 is defined. In some embodiments, for example, the connection includes the pivotable connection 2908. The apparatus 2900 further comprises a trailer connector assembly 2910, similar to the trailer connector assembly 6, disposed on the second frame counterpart 2904 for releasably coupling to a trailer 12 such that the trailer 12 and the apparatus 2900 are translatable together (for example, the trailer 12 is translatable with the apparatus 2900). In some embodiments, for example, the releasable coupling of the apparatus 2900 to the trailer is with effect that the trailer overlaps the apparatus 2900 by a length that is less than an overall length of the trailer.

The apparatus 2900 further comprises a plurality of wheels distributed amongst the first frame counterpart 2902 and the second frame counterpart 2904, wherein each one of the wheels, independently, is coupled to a one of the first frame counterpart 2902 and the second frame counterpart 2904. In some embodiments, for example, as depicted in FIGS. 29 to 34, the apparatus 2900 includes a first front wheel 2912 and a second front wheel 2914 that are rotatably coupled to the first frame counterpart 2902, and further includes a first rear wheel 2916 and a second rear wheel 2918 that are rotatably coupled to the second frame counterpart 2904. In some embodiments, for example, the first frame counterpart 2902, the second frame counterpart 2904, and the wheels are co-operatively configured such that (i) the frame 2906 is supported above a reaction surface, for example, the ground, the floor, the road, and the like, by the wheels, and (ii) the frame 2906 is moveable across the reaction surface in response to rolling movement of the wheels.

As described herein, the apparatus 2900 further comprises an energy storage device 2961, a drive system 2960 operable in a drive mode, and a controller 2930 for selectively activating the drive mode of the drive system 2960. The apparatus 2900 further includes an actuator 2950 for urging pivoting of one of the first frame counterpart 2902 and the second frame counterpart 2904 relative to the other of the first frame counterpart 2902 and the second frame counterpart 2904.

In some embodiments, for example, the first frame counterpart 2902, the second frame counterpart 2904, the actuator 2950, the drive system 2960, the energy storage device 2961, and the controller 2930 are co-operatively configured such that, the drive mode is activatable by the controller 2930 with effect that communication between the energy storage device 2961 and the drive system 2960 is established such that the drive system 2960 stimulates the actuator 2950 to urge pivoting of one of the first frame counterpart 2902 and the second frame counterpart 2904 relative to the other of the first frame counterpart 2902 and the second frame counterpart 2904.

In some embodiments, for example, at least one wheel, the drive system 2960, and the energy-storing device 2961 are co-operatively configured such that while the releasable coupling of a trailer 12 to the apparatus 2900 is effected, and while energy is stored on the energy storing device 2961, the drive system 2960 is operable in the drive mode such that the trailer 12 translates with the apparatus 2900.

In some embodiments, for example, the trailer connector assembly 2910 is a first trailer connector assembly and the trailer 12 is a first trailer, and the apparatus 2900 further comprises a second trailer connector assembly, similar to the trailer connector assembly 7, disposed on the first frame counterpart 2902 for releasably coupling to a second trailer 12 such that the second trailer 12 and the apparatus 2900 are translatable together (for example, apparatus 2900 is translatable with the second trailer 12).

In some embodiments, for example, the pivoting of one of the first frame counterpart 2902 and the second frame counterpart 2904 relative to the other of the first frame counterpart 2902 and the second frame counterpart 2904 is such that steerability of the apparatus 2900 is thereby effectible. In some embodiments, for example, the apparatus 2900 is steerable by effecting pivoting of one of the first frame counterpart 2902 and the second frame counterpart 2904 pivots relative to the other of the first frame counterpart 2902 and the second frame counterpart 2904.

In some embodiments, for example, the drive system 2960 includes at least one motor 2920. The at least at least one motor 2920 is operably coupled to at least one wheel of the front pair of wheels and the rear pair of wheels for applying rotational force to the at least one wheel, and operably coupled to the energy storing device 2961 for receiving energy, such that the motor is operable in the drive mode for applying a motive rotational force to the at least one wheel.

In some embodiments, for example, at least one wheel, the motor 2920, and the energy-storing device 2961 are co-operatively configured such that while the releasable coupling of the trailer 12 to the apparatus 2900 is effected, for example, via the trailer connector assembly 2910, and while the energy is stored on the energy storing device, the motor is operable in the drive mode such that the trailer 12 translates with the apparatus 2900.

In some embodiments, for example, at least one wheel, the motor 2920, and the energy-storing device 2961 are co-operatively configured such that while the releasable coupling of the trailer 12 to the apparatus 2900 is effected, for example, via the trailer connector assembly 2910, and while another trailer is released from the releasable coupling to the apparatus 2900, for example, released from the trailer connector assembly disposed on the first frame counterpart 2902, and while the energy is stored on the energy storing device, the motor is operable in the drive mode such that the trailer 12 translates with the apparatus 2900.

In some embodiments, for example, the drive system 2960 includes a first motor 2920 is operatively coupled to a first front wheel 2912 and a second motor 2920 is operatively coupled to a second front wheel 2914, wherein the first motor 2920 is configured to provide a first rotational motive force to the wheel 2912, and the second motor 2920 is configured to provide a second rotational motive force to the wheel 2914. In some embodiments, for example, the controller 2930 is operably coupled to one or more of the motors 2920 to control the first rotational motive force and the second rotational motive force, and a steering mechanism as described herein or the controller 2930 is configured to steer the apparatus 2900. In some embodiments, for example, the steering mechanism sends instructions to the controller 2930 to differentially control the first motive rotational force and the second motive rotational force, with effect that one of the first frame counterpart 2902 and the second frame counterpart 2904 pivots relative to the other of the first frame counterpart 2902 and the second frame counterpart 2904. In some embodiments, for example, the first motor 2920 is an in-hub motor for the first front wheel 2912. In some embodiments, for example, the second motor 2920 is an in-hub motor for the second front wheel 2914.

In some embodiments, for example, the drive system 2960 includes a first motor 2920 is operatively coupled to a first rear wheel 2916 and a second motor 2920 is operatively coupled to a second rear wheel 2918, wherein the first motor 2920 is configured to provide a first rotational motive force to the wheel 2916, and the second motor 2920 is configured to provide a second rotational motive force to the wheel 2918. In some embodiments, for example, the controller 2930 is operably coupled to one or more of the motors 2920 to control the first rotational motive force and the second rotational motive force, and a steering mechanism as described herein or the controller 2930 is configured to steer the apparatus 2900. In some embodiments, for example, the steering mechanism sends instructions to the controller 2930 to differentially control the first motive rotational force and the second motive rotational force, with effect that one of the first frame counterpart 2902 and the second frame counterpart 2904 pivots relative to the other of the first frame counterpart 2902 and the second frame counterpart 2904. In some embodiments, for example, the first motor 2920 is an in-hub motor for the first rear wheel 2916. In some embodiments, for example, the second motor 2920 is an in-hub motor for the second rear wheel 2918.

In some embodiments, for example, a first motor 2920 is operatively coupled to a first front wheel 2912, a second motor 2920 is operatively coupled to a second front wheel 2914, a third motor 2920 is operatively coupled to a first rear wheel 2916, and a fourth motor 2920 is operatively coupled to a second rear wheel 2918, wherein the first motor 2920 is configured to provide a first rotational motive force to the wheel 2912, the second motor 2920 is configured to provide a second rotational motive force to the wheel 2914, the third motor 2920 is configured to provide a third rotational motive force to the wheel 2916, the fourth motor 2920 is configured to provide a fourth rotational motive force to the wheel 2918. In some embodiments, for example, the controller 2930 is operably coupled to one or more of the motors 2920 to control the first rotational motive force, the second rotational motive force, the third rotation motive force, and the fourth rotational motive force, and a steering mechanism as described herein or the controller 2930 is configured to steer the apparatus 2900. In some embodiments, for example, the steering mechanism sends instructions to the controller 2930 to differentially control the first motive rotational force, the second motive rotational force, the third motive force, and the fourth motive force, with effect that one of the first frame counterpart 2902 and the second frame counterpart 2904 pivots relative to the other of the first frame counterpart 2902 and the second frame counterpart 2904. In some embodiments, for example, the first motor 2920 is an in-hub motor for the first front wheel 2912. In some embodiments, for example, the second motor 2920 is an in-hub motor for the second front wheel 2914. In some embodiments, for example, the third motor 2920 is an in-hub motor for the first rear wheel 2916. In some embodiments, for example, the fourth motor 2920 is an in-hub motor for the second rear wheel 2918.

In some embodiments, for example, the actuator 2950 includes at least one of the wheels of the apparatus 2900 for urging pivoting of one of the first frame counterpart 2902 and the second frame counterpart 2904 relative to the other of the first frame counterpart 2902 and the second frame counterpart 2904.

In some embodiments, for example, for each one of the at least one of the wheels, independently, the drive system 2960 includes at least one corresponding in-hub motor 2920 operably coupled to the wheel.

In some embodiments, for example, the drive system 2960 is an actuator-stimulating drive system, such that the drive system 2960 stimulates the actuator 2950 for urging the pivoting of one of the first frame counterpart 2902 and the second frame counterpart 2904 pivots relative to the other of the first frame counterpart 2902 and the second frame counterpart 2904. In such embodiments, for example, the apparatus 2900 further includes an apparatus displacement-stimulating drive system operably coupled to at least one of the wheels with effect that, for each one of the at least one operatively coupled wheels, independently, the operable coupling is with effect that the apparatus displacement-stimulating drive system is operable for driving the operatively-coupled wheel. In some embodiments, for example, the apparatus displacement-stimulating drive system includes the in-hub motors that are operably connected to the wheels of the apparatus 2900. In some embodiments, for example, the apparatus displacement-stimulating drive system includes at least one motor operably coupled to at least one of the wheels with effect that, for each one of the at least one operatively coupled wheels, independently, the operable coupling is with effect that the at least one motor of the apparatus displacement-stimulating drive system is operable for driving the operatively-coupled wheel.

In some embodiments, for example, the apparatus 2900 comprises the actuator 2950 that is disposed in operable communication with the first frame counterpart 2902 and the second frame counterpart 2904, and is co-operatively configured with the first frame counterpart 2902 and the second frame counterpart 2904 such that the actuator 2950 is activatable to effect pivoting of one of the first frame counterpart 2902 and the second frame counterpart 2904 relative to the other of the first frame counterpart 2902 and the second frame counterpart 2904. In some embodiments, for example, the controller 2930 is configured to selectively activate the actuator 2950, and a steering device as described herein is configured to steer the apparatus 2900 by sending instructions to the controller 2930 to activate the actuator 2950 to pivot one of the first frame counterpart 2902 and the second frame counterpart 2904 relative to the other of the first frame counterpart 2902 and the second frame counterpart 2904.

In some embodiments, for example, the actuator 2950 includes a linear actuator that is activatable to extend and retract for effecting the pivoting of one of the first frame counterpart 2902 and the second frame counterpart 2904 relative to the other of the first frame counterpart 2902 and the second frame counterpart 2904.

In some embodiments, for example, the pivotable connection 2908 of the first frame counterpart 2902 and the second frame counterpart 2904 is disposed about a central longitudinal axis 2980 of the frame 2906, and the actuator 2950, for example, the linear actuator of the actuator 2950, is disposed offset from the central longitudinal axis 2980.

In some embodiments, for example, as depicted in FIGS. 29 to 34, the actuator 2950 of the apparatus 2900 includes a first actuator 2922 and a second actuator 2924 that are disposed in operable communication with the first frame counterpart 2902 and the second frame counterpart 2904, and are co-operatively configured with the first frame counterpart 2902 and the second frame counterpart 2904 such that the first actuator 2922 and the second actuator 2924 are activatable to effect pivoting of one of the first frame counterpart 2902 and the second frame counterpart 2904 relative to the other of the first frame counterpart 2902 and the second frame counterpart 2904. In some embodiments, for example, the controller 2930 is configured to selectively activate the first actuator 2922 and the second actuator 2924, and a steering device is described herein configured to steer the apparatus 2900 by sending instructions to the controller 2930 to activate the first actuator 2922 and the second actuator 2924 to pivot one of the first frame counterpart 2902 and the second frame counterpart 2904 relative to the other of the first frame counterpart 2902 and the second frame counterpart 2904.

In some embodiments, for example, the pivotable connection 2908 of the first frame counterpart 2902 and the second frame counterpart 2904 is disposed about a central longitudinal axis 2980 of the frame 2906, the central longitudinal axis 2980 defining a first side and a second side of the frame 2906. In some embodiments, for example, as depicted in FIG. 29, the first actuator 2922 is disposed on the first side of the frame 2906 and offset from the central longitudinal axis 2980, and the second actuator 2924 is disposed on the second side of the frame 2906 and offset from the central longitudinal axis 2980.

In some embodiments, for example, the first actuator 2922 and the second actuator 2924 are linear actuators that are activatable to extend and retract for effecting the pivoting of one of the first frame counterpart 2902 and the second frame counterpart 2904 relative to the other of the first frame counterpart 2902 and the second frame counterpart 2904.

In some embodiments, for example, the one of the first frame counterpart 2902 and the second frame counterpart 2904 pivots relative to the other of the first frame counterpart 2902 and the second frame counterpart 2904 about a vertical axis 2990 that is perpendicular to a central longitudinal axis 2980 of the apparatus 2900.

In some embodiments, for example, the apparatus 2900 includes a kinetic energy recovery device, as described herein, configured to recover energy from regenerative braking of at least one wheel of the plurality of wheels of the apparatus 2900. In some embodiments, for example, the kinetic energy recovery device is operably coupled to at least one wheel of the plurality of wheels of the apparatus 2900 for converting mechanical energy generated by rotation of the at least one wheel to recoverable energy. In some embodiments, for example, the kinetic energy recovery device includes at least one motor-generator operably coupled to the at least one wheel, wherein the at least one motor-generator is operable in: (i) a drive mode for applying motive rotational force to the at least one wheel, and (ii) a generator mode for converting the kinetic energy to recoverable energy, the generator mode effecting deceleration of the at least one wheel. In some embodiments, for example, the controller 2930 is operably coupled to the at least one motor-generator for selectively activating the drive mode or the generator mode.

In some embodiments, for example, while: (i) the releasable coupling of the apparatus 2900 to a first trailer is effected, for example, via the trailer connector assembly disposed on the first frame counterpart 2902, (ii) the releasable coupling of the apparatus 2900 to a second trailer is effected, for example, via the trailer connector assembly 2910 disposed on the second frame counterpart 2904, (iii) the first trailer is coupled to a towing vehicle in a tractor-trailer vehicle configuration, the trailer connector assembly disposed on the first frame counterpart 2902, the trailer connector assembly 2910, the at least one wheel, and the kinetic energy recovery device are cooperatively configured such that while the first trailer translates with the towing vehicle, and the releasable coupling of the apparatus 2900 to the first trailer and to the second trailer is effected, braking by the towing vehicle is with effect that the kinetic energy recovery device converts kinetic energy generated by rotation of the at least one wheel to recoverable energy.

In some embodiments, for example, while: (i) the releasable coupling of the apparatus 2900 to a first trailer is effected, for example, via the trailer connector assembly disposed on the first frame counterpart 2902, (ii) the releasable coupling of the apparatus 2900 to a second trailer is effected, for example, via the trailer connector assembly 2910 disposed on the second frame counterpart 2904, (iii) the first trailer is coupled to a towing vehicle in a tractor-trailer vehicle configuration, the trailer connector assembly disposed on the first frame counterpart 2902, the trailer connector assembly 2910, the at least one wheel, and the kinetic energy recovery device are cooperatively configured such that while the first trailer translates with the towing vehicle and the releasable coupling of the apparatus to the first trailer and to the second trailer is effected, and the towing vehicle is decelerating, the kinetic energy recovery device converts the mechanical energy to recoverable energy.

In some embodiments, for example, the energy storing device 2961 is operably connected to the kinetic energy recovery device, and the recoverable energy is stored in the energy storing device 2961. In some embodiments, for example, the kinetic energy recovery device and the energy-storing device 2961 are disposed intermediate the trailer connector assembly disposed on the first frame counterpart 2902 and the trailer connector assembly 2910 disposed on the second frame counterpart 2904 to locate these components farther from the underbody of the trailer connected to the apparatus 2900 via the trailer connector assembly 2910 for facilitating cooling and reducing mechanical interference from said trailer.

In some embodiments, for example, the dollies, yard shifters, terminal tractors, or the apparatus 2900, as described herein, are part of a kit for an apparatus for towing trailers.

In some embodiments, for example, the dollies, the terminal tractors, and the yard shifters as described herein include an articulated frame having a first frame counterpart pivotably connected to a second frame counterpart as described with respect to the apparatus 2900.

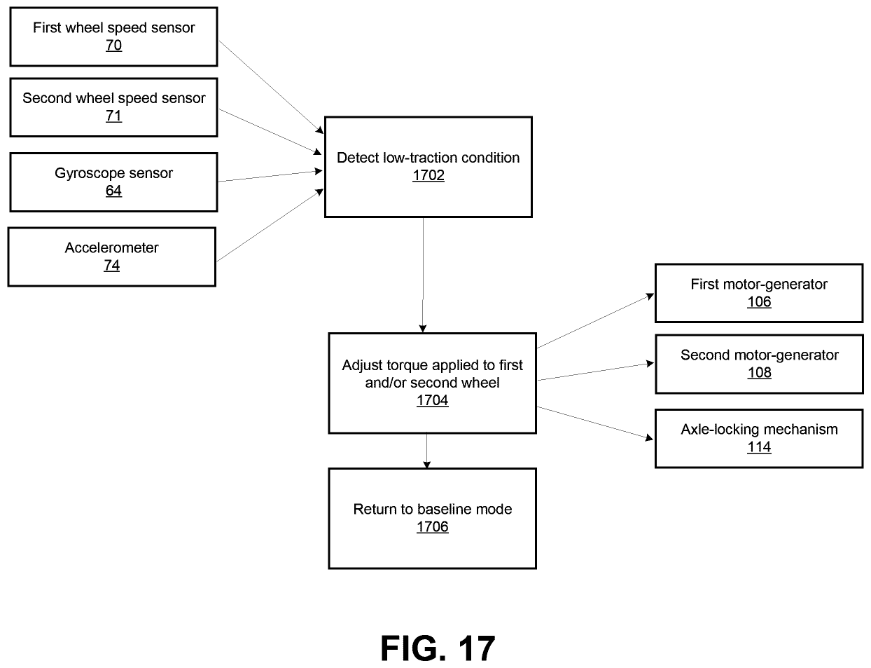

FIGS. 17 to 20 show the operation of the controller 502 in relation to other vehicle systems while operating in the various modes described briefly above.

In FIG. 17, an example operation of the stability-assistance mode is shown as a flowchart. At step 1702, the controller 502 operates to detect a low-traction condition based at least in part on data provided by the first wheel speed sensor 70, the second wheel speed sensor 71, the gyroscope sensor 64, and the linear accelerometer 74. In some embodiments, this detection 1702 may be based entirely on data from the wheel speed sensors 70, 71 indicating that one wheel is rotating significantly faster than the other, for example that the difference between the speed of the first wheel 102 and the speed of the second wheel 104 is above a certain threshold. In other embodiments, this wheel speed data may be supplemented or replaced in the detection step 1702 by angular acceleration data from the gyroscope sensor 64 and linear acceleration data from the linear accelerometer 74 indicating that the yaw acceleration (i.e. angular acceleration about a vertical Z-axis) of the dolly 14 has increased or is above a certain threshold while the dolly 14 is moving forward.

When the low-traction condition has been detected at step 1702, the controller then adjusts the motive rotational force applied to the wheels at step 1704. Depending on the configuration of the dolly 14, the adjustment may be to the motive rotational force applied to one or both wheels of the apparatus 14.

For example, in a differential configuration such as the one shown in FIG. 16, the electronic locking device 114 will lock the differential drive, essentially turning the two drive shafts 110,111 into a single solid axle. Such action will transfer the motive rotational force to the wheel with traction and therefore reduce the instability of the converter dolly 14. In some embodiments, when the low-traction condition is detected, the system will also cut power to the motor-generator 36 to reduce the motive rotational force output to the wheels 102,104. This may be seen as the application of Vehicle Control System or Vehicle Stability System technology to the active converter dolly 14.

In an in-wheel motor-generator configuration such as the one shown in FIG. 15, the motive rotational force or motive rotational force applied to the first wheel 102 by the first motor-generator 106 may be reduced if the first wheel 102 is detected to be slower than the second wheel 104, and vice-versa with respect to the second motor-generator 108 and second wheel 104. Alternatively or in addition, the motive rotational force or motive rotational force applied to the slower wheel may be increased, or regenerative braking may be applied (or increased in intensity) to the faster wheel.

When yaw acceleration is detected as part of the low-traction condition at step 1702, the adjustment of motive rotational force or motive rotational force at step 1704 may comprise adjusting wheel motive rotational force to counteract the yaw acceleration. For example, when clockwise yaw acceleration is detected, the motive rotational force or motive rotational force applied to the first wheel 102 on the left side of the frame 24 may be decreased, or the motive rotational force applied to the second wheel 104 on the right side of the frame 24 may be increased to generate offsetting counter-clockwise yaw acceleration.

At step 1706, the controller 502 detects that the low-traction mode is no longer present or has been addressed, and the corrective action is discontinued, returning the dolly 14 to a baseline operating mode in which the motive rotational force applied to each wheel follows the standard rules set out above with regard to the various operating modes (drive mode, generator mode, passive mode). This determination may be based on wheel speed data and/or angular and linear acceleration data.

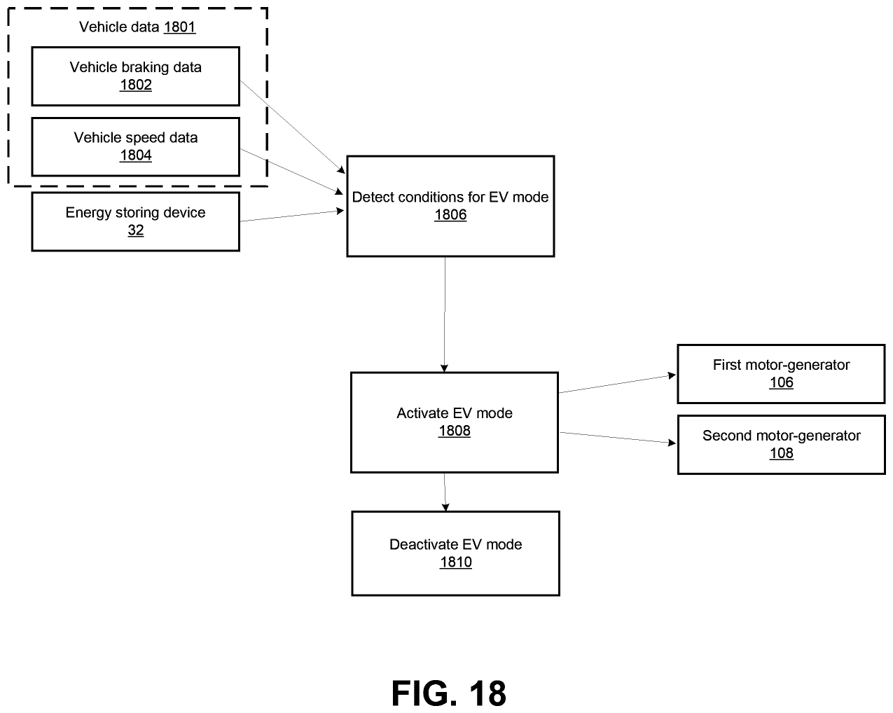

In FIG. 18, an example operation of the electric-vehicle (EV) mode is shown as a flowchart. Electric-vehicle mode may be used by the dolly apparatus 14 to drive the tractor-trailer vehicle 10 forward in low-speed conditions, such as slow-moving traffic congestion conditions, with or without the use of the drive of the towing vehicle (e.g., internal combustion engine) being engaged. At step 1806, the controller 502 operates to detect a set of conditions based at least in part on vehicle data 1801 received from the towing vehicle 13 and optionally the SOC of the energy storing device 32 (e.g., battery). The vehicle data 1801 may be received in some embodiments over the electrical connection 72 or the communication interface 68. As noted above, the dolly apparatus 14 may be connected to the OBD II port of the towing vehicle 13 to monitor the real-time operating information from the CAN bus of the towing vehicle 13.

In the illustrated example, the vehicle data 1801 includes vehicle braking data 1802 indicating the degree of braking being applied by the driver of the towing vehicle 13, and vehicle speed data 1804 indicating the speed of the towing vehicle 13 or the entire tractor-trailer vehicle 10. The braking data 1802 may indicate in some embodiments the degree of depression of the brake pedal of the towing vehicle, from 0% depression (no braking) to 100% depression (full braking).

In some embodiments, the conditions for activation of electric-vehicle mode include detecting at step 1804: that the degree of braking is below a braking threshold, that the speed of the vehicle is below a speed threshold, and that the charge of the energy storing device 32 is above a SOC threshold. If these conditions are met, the electric-vehicle mode is activated at step 1808. The braking threshold, speed threshold and SOC threshold may vary between embodiments. For an example, the braking threshold may be between 10% and 50% braking, between 20% and 40% braking, between 25 and 35% braking or approximately 30%. For another example, the speed threshold may be between 5 km/h and 45 km/h, between 10 km/h and 40 km/h, between 20 km/h and 30 km/h, or approximately between 25. For yet another example, the SOC threshold may be between 10% and 40% of a full charge level, between 20% and 30% of a full charge level, or approximately 25% of a full charge level.

In electric-vehicle mode, the motor-generators 36 of the dolly 14 are used to drive the apparatus 14, and therefore the tractor-trailer 10, forward. For example, a first motor-generator 106 and second motor-generator 108 may be used to drive wheels on both sides of the dolly 14 forward to move the vehicle in slow speed conditions.

The controller 502 in some embodiments may deactivate electric-vehicle mode at step 1810 upon detecting that the conditions detected at step 1806 no longer hold. For example, if the driver applies the brakes above the braking threshold, or if the charge level of the energy storing device 32 drops below the SOC threshold, or the speed of the vehicle rises above the speed threshold, then the electric-vehicle mode may be deactivated.

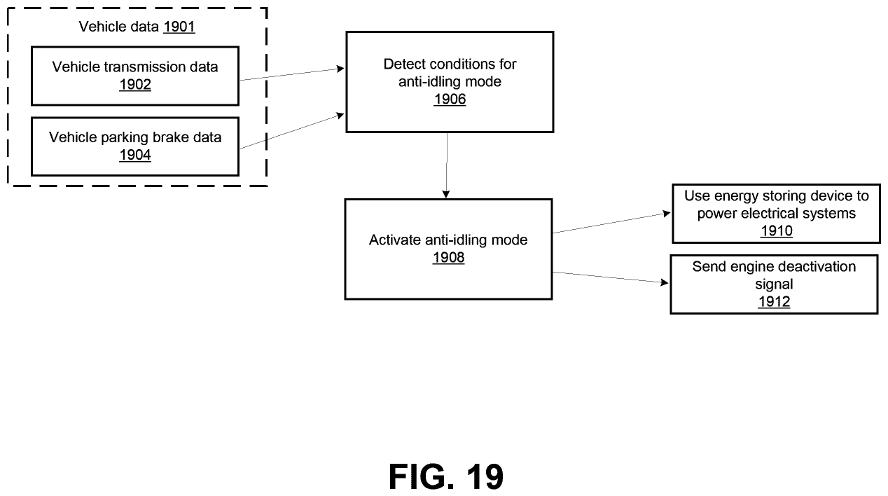

In FIG. 19, an example operation of the anti-idling mode is shown as a flowchart. Anti-idling mode may be used by the apparatus 14 to power various electrical systems of the tractor-trailer 10 using the energy storing device 32 when the vehicle is idling, temporarily stopped or parked, without having to run the engine of the towing vehicle 13 to maintain power. High voltage cables may be used to connect the apparatus 14 to the first trailer 12a and through the first trailer 12 to the towing vehicle 13. A DC-DC converter may be used by the towing vehicle to step down the high voltage of the energy storage device 32 (i.e., battery) to match the low voltage system of the auxiliary components of the towing vehicle 13. A control system may be used to automatically shut off the engine of the towing vehicle 13 and subsequently restart the engine. Depending on the characteristics of the towing vehicle 13, the engine starter may be modified from manufacturer's condition so that the apparatus 14 may operate in the anti-idling mode.

The controller 502 operates to detect the conditions for activation of anti-idling mode at step 1906, based at least in part on received vehicle data 1901. With respect to anti-idling mode in the illustrated example, the vehicle data 1901 used by the controller 502 at step 1906 includes vehicle transmission data 1902 indicating the state of the transmission of the towing vehicle 13 (e.g. whether the engine is on but the towing vehicle 13 is in park, neutral, reverse, or a drive gear). In some embodiments, such as some embodiments configured to be used with a towing vehicle 13 with a manual transmission, the vehicle data 1901 may also include towing vehicle parking brake data 1904 indicating the state of the towing vehicle's parking brake (e.g. engaged or not engaged).

Anti-idling mode may be activated by the controller 502 upon detecting at step 1906 that the towing vehicle 13 is stopped for at least a predetermined amount of time, the towing vehicle 13 is in a parked state, or both. The predetermined amount of time may vary between in embodiments. In some embodiments, the predetermined amount of time is between 10 and 60 seconds, between 15 and 45 seconds, or approximately 30 seconds. Detecting that towing vehicle 13 is in a parked state is in a parked state may, in some embodiments, comprise detecting that the towing vehicle 13 has its transmission set to a parked state based on the transmission data 1902. In other embodiments, such as some embodiments configured to be used with a towing vehicle 13 with a manual transmission, this may comprise detecting that the transmission is in park gear and optionally detecting that the parking brake is engaged.

When anti-idling mode is activated at step 1908, the stored power in the energy storing device 32 may be used to power one or more electrical systems of the tractor-trailer 10 at step 1910. The power may be relayed via the electrical connection 72. Examples of such systems include HVAC systems used in the towing vehicle 13; refrigeration or HVAC systems used in the first trailer 12a or second trailer 12b; lights, stereo system, or other user amenities in the towing vehicle 13; lights on the towing vehicle 13 or the trailers 12a, 12b; or any other electrical system on the towing vehicle 13, first trailer 12a, second trailer 12b, or dolly apparatus 14. The voltage of the energy storing device 32 may be significantly higher than the systems being powered in some embodiments; in such embodiments, the electrical connection 72 may include one or more DC-DC converters or transformers as described above for stepping down the voltage.

In some embodiments, the controller 502 may further operate to shut off the engine of the towing vehicle at step 1912 in response to activating anti-idling mode. The controller 502 may send an engine deactivation signal via the communication interface 68 or electrical connection 72, as further described above, to deactivate the engine of the towing vehicle 13 to prevent idling. In other embodiments, the engine may be shut down manually or some other system may be used to shut down the engine when anti-idling mode is active. Some embodiments may also be configured to restart the engine using a process as described above.

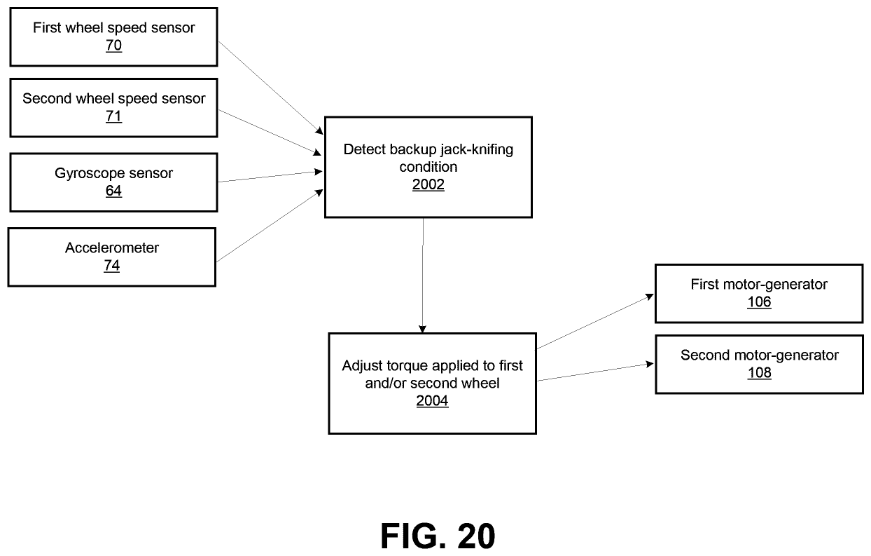

In FIG. 20, an example operation of the backup-assistance mode is shown as a flowchart. Backup-assistance mode in the illustrated example operates in a similar manner to stability-assistance mode, but generally operates at lower speeds and is activated under different conditions. Its purpose is to keep the tractor-trailer straight when backing up and to prevent jack-knifing conditions whereby one or more of the trailers 12a, 12b deviates from the longitudinal orientation of the tractor-trailer vehicle 10 as a whole.

At step 2002, much like in low-traction detection step 1702 of FIG. 17, the controller 502 detects that the wheels of the dolly 14 are moving at different speeds and/or are creating yaw acceleration of the dolly 14, using a combination of wheel speed, angular acceleration, and/or linear acceleration data. If this happens while the dolly 14 is moving backward, it would indicate that the dolly is turning. Although there may be times that a driver intends to cause the trailers to turn when backing up, this intention may in some embodiments be indicated by a user input communicated to the controller 502 as vehicle data, much like vehicle data 1801 or 1901. The process illustrated in FIG. 20 assumes that backup-assistance mode has not been deactivated by the driver to allow the trailers to turn when backing up.

If the controller detects at step 2002 that the dolly is turning (i.e. that a jack-knifing condition is present), motive rotational force applied to the wheels is adjusted at step 2004 much like the remedial motive rotational force adjustments applied in stability-assistance mode in FIG. 17. For example, if the dolly is turning to the right (counter-clockwise) while backing up, the motive rotational force applied to a right-hand-side second wheel 104 by a second motor-generator 108 may be increased, thereby causing the dolly 14 to experience yaw acceleration clockwise. Other variations on motive rotational force adjustment using the motor functions and/or the braking functions of the motor-generators 36 are as described above with respect to stability-assistance mode.

In one aspect, the apparatus of the disclosure provides advantages over current converter dollies. For instance, in some embodiments, the active converter dolly 14 of the disclosure reduces fuel consumption emission levels. In some embodiments, the active dolly may operate to assist in fulfilling a power demand (acceleration, grade ability and maximum, or highest, cruising speed) of the tractor-trailer 10. In some embodiments, the disclosure is directed at maintaining a battery's state of charge (SOC) within a reasonable level, for self-sustaining operation whereby no external charging is required. In addition, the disclosure is directed at an active converter dolly that may be able to harvest braking energy to generate electricity.

It will be appreciated by those skilled in the art that various modifications and alterations can be made to the present invention without departing from the scope of the invention as defined by the appended claims. Some of these have been suggested above and others will be apparent to those skilled in the art. For example, although a preferred form of the present disclosure includes separate motors for each wheel set, the present invention can also be used with a cross axle and differential in and single electrical power source, provided the same provides enough total energy to hybridize the truck travel.

In some embodiments, for example, as described herein, the motor for driving the dolly, converter dolly, terminal tractor, or the yard shifter, or pivoting the articulated frame, is an electric motor. In some embodiments, for example, the motor is a diesel drive motor. In some embodiments, for example, the drive system includes a fuel cell. In some embodiments, for example, the motor is powered by natural gas. In some embodiments, for example, the motor is powered by biofuel.

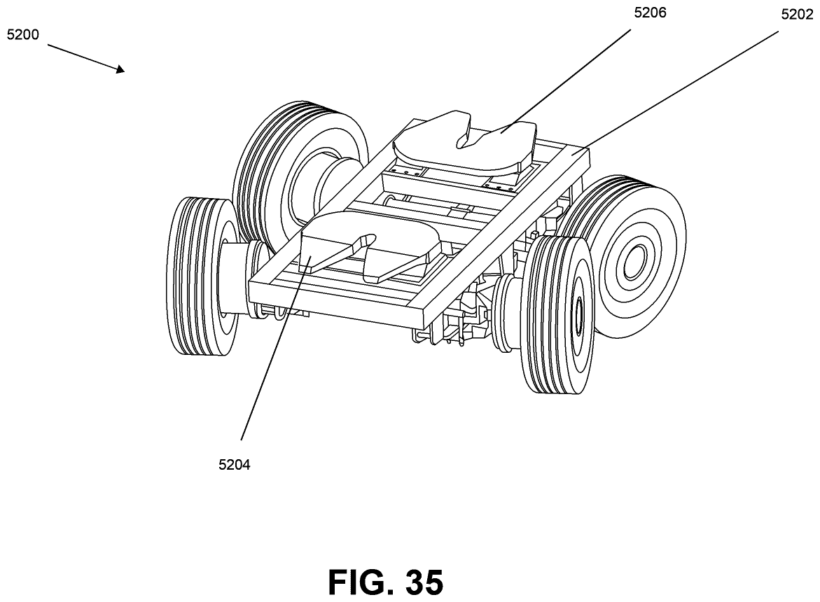

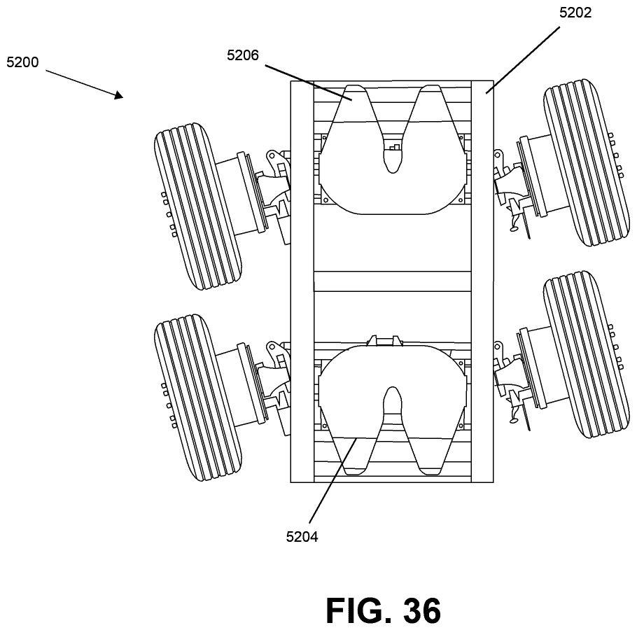

FIG. 35 and FIG. 36 depicts an alternate embodiment of an apparatus 5200 for towing a vehicle. The apparatus 5200 substantially corresponds to the dollies described herein, except the frame 5202 of the apparatus 5200 is an elongated frame 5202, and includes a first trailer connector assembly 5204, for example, a first fifth wheel, and a second trailer connector assembly 5206, for example a second fifth wheel. The apparatus 5200 is configured to be releasably coupled to a first trailer on the front end and a second trailer on the back end of the apparatus 5200 to define a connected series of trailers. In some embodiments, for example, the apparatus 5200 has an articulated frame wherein a first frame counterpart is pivotably connected to a second frame counterpart as described with respect to apparatus 2900.

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described for execution by a controller (or processor) of the dolly apparatus 14 or other apparatus is within the scope of a person of ordinary skill in the art having regard to the present disclosure. Machine readable code executable by one or more processors of one or more respective devices to perform the above-described method may be stored in a machine readable medium such as the memory of the data manager. The terms “software” and “firmware” are interchangeable within the present disclosure and comprise any computer program stored in memory for execution by a processor, comprising RAM memory, ROM memory, erasable programmable ROM (EPROM) memory, electrically EPROM (EEPROM) memory, and non-volatile RAM (NVRAM) memory. The above memory types are example only, and are thus not limiting as to the types of memory usable for storage of a computer program.

All values and sub-ranges within disclosed ranges are also disclosed. In addition, although the systems, devices and processes disclosed and shown herein may comprise a specific plurality of elements/components, the systems, devices and assemblies may be modified to comprise additional or fewer of such elements/components. For example, although any of the elements/components disclosed may be referenced as being singular, the embodiments disclosed herein may be modified to comprise a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a data manager) to execute examples of the methods disclosed herein.

The term “processor” may comprise any programmable system comprising systems using micro- or nano-processors/controllers, reduced instruction set circuits (RISC), application specific integrated circuits (ASICs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1.-32. (canceled)

33. An apparatus for releasably coupling a second trailer to a first trailer that is releasably coupled to a towing vehicle in a tractor-trailer vehicle configuration, the apparatus comprising:
a first frame counterpart and a second frame counterpart that are pivotably connected to define a frame;
a first trailer connector assembly disposed on the first frame counterpart for releasably coupling the apparatus to the first trailer such that the apparatus translates with the first trailer;
a second trailer connector assembly disposed on the second frame counterpart for releasably coupling the apparatus to the second trailer such that the second trailer translates with the apparatus;
a front pair of wheels rotatably coupled to the first frame counterpart;
a rear pair of wheels rotatably coupled to the second frame counterpart;
an energy storing device for storing energy;
at least one motor operably coupled to: (i) at least one wheel of the front pair of wheels and the rear pair of wheels for applying rotational force to the at least one wheel, and (ii) the energy storing device for receiving energy, such that the motor is operable in a drive mode for applying a motive rotational force to the at least one wheel; and
a controller for selectively activating the drive mode of the motor;
a steering device communicatively coupled to the controller for steering the apparatus, the apparatus being operable by the steering device to shunt the second trailer around a staging area when the second trailer is disconnected from the towing vehicle,
wherein the at least one wheel, the motor, and the energy-storing device are co-operatively configured such that while the first trailer is released from the releasable coupling to the apparatus and the releasable coupling of the second trailer to the apparatus is effected, and while the energy is stored on the energy storing device, the motor is operable in the drive mode such that the second trailer translates with the apparatus; and
the apparatus is steerable by effecting pivoting of one of the first frame counterpart and the second frame counterpart pivots relative to the other of the first frame counterpart and the second frame counterpart.

34. The apparatus of claim 33, wherein:
the at least one motor comprises a first motor operatively coupled to a first wheel of the front pair of wheels and a second motor operatively coupled to a second wheel of the front pair of wheels;
the first motor is configured to provide a first rotational motive force to the first wheel;
the second motor is configured to provide a second rotational motive force to the second wheel;
the controller is operably coupled to the at least one motor to control the first rotational motive force and the second rotational motive force; and
the steering device is configured to steer the apparatus by sending instructions to the controller to differentially control the first motive rotational force and the second motive rotational force, with effect that one of the first frame counterpart and the second frame counterpart pivots relative to the other of the first frame counterpart and the second frame counterpart.

35. The apparatus of claim 33, wherein:
the at least one motor comprises a first motor operatively coupled to a first wheel of the rear pair of wheels and a second motor operatively coupled to a second wheel of the rear pair of wheels;
the first motor is configured to provide a first rotational motive force to the first wheel;
the second motor is configured to provide a second rotational motive force to the second wheel;
the controller is operably coupled to the at least one motor to control the first rotational motive force and the second rotational motive force; and
the steering device is configured to steer the apparatus by sending instructions to the controller to differentially control the first motive rotational force and the second motive rotational force, with effect that one of the first frame counterpart and the second frame counterpart pivots relative to the other of the first frame counterpart and the second frame counterpart.

36. The apparatus of claim 33, wherein:
the at least one motor comprises:
a first motor operatively coupled to a first wheel of the front pair of wheels;
a second motor operatively coupled to a second wheel of the front pair of wheels;
a third motor operatively coupled to a first wheel of the rear pair of wheels;
a fourth motor operatively coupled to a second wheel of the rear pair of wheels;
the first motor is configured to provide a first rotational motive force to the first wheel of the front pair of wheels;
the second motor is configured to provide a second rotational motive force to the second wheel of the front pair of wheels;
the third motor is configured to provide a third rotational motive force to the first wheel of the rear pair of wheels;
the fourth motor is configured to provide a fourth rotational motive force to the second wheel of the rear pair of wheels;
the controller is operably coupled to the at least one motor to control the first, second, third, and fourth rotational motive forces; and
the steering device is configured to steer the apparatus by sending instructions to the controller to differentially control the first, second, third, and fourth motive rotational forces, with effect that one of the first frame counterpart and the second frame counterpart pivots relative to the other of the first frame counterpart and the second frame counterpart.

37. The apparatus of claim 33, further comprising:
an actuator that is disposed in operable communication with the first frame counterpart and the second frame counterpart, and is co-operatively configured with the first frame counterpart and the second frame counterpart such that the actuator is activatable to effect pivoting of one of the first frame counterpart and the second frame counterpart relative to the other of the first frame counterpart and the second frame counterpart;
wherein the controller is configured to selectively activate the actuator; and
the steering device is configured to steer the apparatus by sending instructions to the controller to activate the actuator to pivot one of the first frame counterpart and the second frame counterpart relative to the other of the first frame counterpart and the second frame counterpart.

38. The apparatus of claim 37 wherein:
the pivotable connection of the first frame counterpart and the second frame counterpart is disposed about a central longitudinal axis of the frame; and
the actuator is disposed offset from the central longitudinal axis.

39. The apparatus of claim 37, wherein the actuator is a linear actuator that is activatable to extend and retract for effecting the pivoting of one of the first frame counterpart and the second frame counterpart relative to the other of the first frame counterpart and the second frame counterpart.

40. The apparatus of claim 33, further comprising:
a first actuator and a second actuator that are disposed in operable communication with the first frame counterpart and the second frame counterpart, and are co-operatively configured with the first frame counterpart and the second frame counterpart such that the first actuator and the second actuator are activatable to effect pivoting of one of the first frame counterpart and the second frame counterpart relative to the other of the first frame counterpart and the second frame counterpart;
wherein the controller is configured to selectively activate the first actuator and the second actuator; and
the steering device is configured to steer the apparatus by sending instructions to the controller to activate the first actuator and the second actuator to pivot one of the first frame counterpart and the second frame counterpart relative to the other of the first frame counterpart and the

41. The apparatus of claim 40, wherein:
the pivotable connection of the first frame counterpart and the second frame counterpart is disposed about a central longitudinal axis of the frame, the central longitudinal axis defining a first side and a second side of the frame; and
the first actuator is disposed on the first side of the frame and offset from the central longitudinal axis, and the second actuator is disposed on the second side of the frame and offset from the central longitudinal axis.

42. The apparatus of claim 40, wherein the first actuator and the second actuator are linear actuators that are activatable to extend and retract for effecting the pivoting of one of the first frame counterpart and the second frame counterpart relative to the other of the first frame counterpart and the second frame counterpart.

43. The apparatus of claim 33, wherein the one of the first frame counterpart and the second frame counterpart pivots relative to the other of the first frame counterpart and the second frame counterpart about a vertical axis that is perpendicular to a central longitudinal axis of the apparatus.

44. The apparatus of claim 33, wherein the at least one motor is an electric motor.

45. A terminal tractor apparatus for towing trailers, the apparatus comprising:
a first frame counterpart and a second frame counterpart that are pivotably connected to define a frame;
a trailer connector assembly disposed on the second frame counterpart for releasably coupling the apparatus to a trailer such that the trailer translates with the apparatus;
a front pair of wheels rotatably coupled to the first frame counterpart;
a rear pair of wheels rotatably coupled to the second frame counterpart;
an energy storing device for storing energy;
at least one motor operably coupled to at least one wheel of the front pair of wheels and the rear pair of wheels for applying rotational force to the at least one wheel and to the energy storing device for receiving energy, such that the motor is operable in a drive mode for applying a motive rotational force to the at least one wheel; and
a controller for selectively activating the drive mode of the motor;
a steering device communicatively coupled to the controller for steering the apparatus, the apparatus being operable by the steering device to shunt the trailer around a staging area while the trailer is releasably coupled to the apparatus;
wherein the at least one wheel, the motor, and the energy-storing device are co-operatively configured such that while the trailer is releasably coupled to the apparatus, and while the energy is stored on the energy storing device, the motor is operable in the drive mode such that the trailer translates with the apparatus; and
the apparatus is steerable by effecting pivoting of one of the first frame counterpart and the second frame counterpart pivots relative to the other of the first frame counterpart and the second frame counterpart.

46. An apparatus for towing trailers, the apparatus comprising:
a first frame counterpart and a second frame counterpart;
wherein:
the first frame counterpart is connected to the second frame counterpart such that a frame is defined; and
the connection includes a pivotable connection;
a trailer connector disposed on the second frame counterpart for releasably coupling to a trailer such that the trailer is translatable with the apparatus;
a plurality of wheels distributed amongst the first and second frame counterparts, wherein each one of the wheels, independently, is coupled to a one of the first and second frame counterparts;
wherein the first frame counterpart, the second frame counterpart, and the wheels are co-operatively configured such that:
(i) the frame is supported above a reaction surface by the wheels; and
(ii) the frame is moveable across the reaction surface in response to rolling movement of the wheels;
an energy storage device;
an actuator;
a drive system operable in a drive mode;
a controller for selectively activating the drive mode of the drive system;
wherein the first frame counterpart, the second frame counterpart, the actuator, the drive system, the energy storage device, and the controller are co-operatively configured such that, the drive mode is activatable by the controller with effect that communication between the energy storage device and the drive system is established such that the drive system stimulates the actuator to urge pivoting of one of the first frame counterpart and the second frame counterpart relative to the other of the first frame counterpart and the

47. The apparatus of claim 46, wherein the trailer connector is a first trailer connector and the trailer is a first trailer, further comprising a trailer connector disposed on the first frame counterpart for releasably coupling to a second trailer such that the second trailer is translatable with the apparatus.

48. The apparatus of claim 47, wherein the pivoting of one of the first frame counterpart and the second frame counterpart relative to the other of the first frame counterpart and the second frame counterpart is such that steerability of the apparatus is thereby effectible.

49. The apparatus of claim 46, wherein the plurality of wheels includes a first pair of wheels rotatably coupled to the first frame counterpart, and a second pair of wheels rotatably coupled to the second frame counterpart.

50. The apparatus of claim 46, wherein the drive system is an actuator-stimulating drive system; and further comprising an apparatus displacement-stimulating drive system operably coupled to at least one of the wheels with effect that, for each one of the at least one operatively coupled wheels, independently, the operable coupling is with effect that the apparatus displacement-stimulating drive system is operable for driving the operatively-coupled wheel.

51. The apparatus of claim 46, wherein the actuator includes at least one of the wheels.

52. The apparatus of claim 51, wherein for each one of the at least one of the wheels, independently, the drive system includes at least one corresponding in-hub motor operably coupled to the wheel.
